(19) United States
(12) Patent Application Publication
(10) Pub. No.: US 2026/0271031 A1
(43) Pub. Date: Sep. 10, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Chao LUO, Shanghai (CN); Yinan ZHAO, Shanghai (CN); Renmao LIU, Shanghai (CN)

(21) Appl. No.: 19/168,984

(22) PCT Filed: Mar. 28, 2024
(86) PCT No.: PCT/CN2024/084389

§ 371 Date: Sep. 25, 2025

(30) Foreign Application Priority Data
Mar. 31, 2023 (CN) 202310341542.4

(51) Int. Cl. H04W 72/25; H04W 72/232

(52) U.S. Cl. CPC H04W 72/25; H04W 72/232

(57) ABSTRACT

Provided in the present invention are a method performed by a user equipment, and a user equipment. The method performed by the user equipment includes: receiving a DCI format 3_0; and performing one or more PSSCH transmissions scheduled by the DCI format 3_0, wherein an RB set with a lowest index allocated to one initial PSSCH transmission of the one or more PSSCH transmissions is indicated by a “lowest index of the RB set allocation to the initial transmission” field in the DCI format 3_0.

### TECHNICAL FIELD

The present invention relates to a method performed by a user equipment, and a user equipment.

### BACKGROUND ART

In a wireless communication system, information may be exchanged between different communication nodes. Wireless communication may be performed on a licensed spectrum and/or an unlicensed spectrum. One example of a wireless communication system is a system standardized by the 3rd Generation Partnership Project (3GPP), for example, a 4G system based on Long-Term Evolution (LTE) radio access technology or an evolved system thereof, or a 5G system based on New Radio (NR) radio access technology or an evolved system thereof. In a communication system based on 3GPP specifications, examples of the communication nodes may include a user equipment (UE) and a base station (e.g., an eNB or a gNB). A radio link from a base station to a UE may be referred to as a downlink (DL). A radio link from a UE to a base station may be referred to as an uplink (UL). A radio link between UEs may be referred to as a sidelink (SL). An interface for wireless transmission and/or reception between a base station and a UE may be referred to as a Uu interface (e.g., an NR-Uu interface based on NR, or an LTE-Uu interface based on LTE). An interface for wireless transmission and/or reception between UEs may be referred to as a PC5 interface (e.g., an NR-PC5 interface based on NR, or an LTE-PC5 interface based on LTE).

In order to support communication on a licensed spectrum and/or an unlicensed spectrum, a series of issues need to be addressed, such as channel access mechanisms, physical layer channel and/or signal structures, physical layer control information and/or signaling procedures (e.g., a synchronization procedure and a feedback and/or determination mechanism), control information and/or signaling procedures of a higher layer, resource allocation and/or management, and coexistence among different systems.

### PRIOR ART DOCUMENTS

### Non-Patent Documents

Non-Patent Document 1: RP-170379, Revision of SI: Study on New Radio Access Technology, 3GPP TSG RAN Meeting #75
Non-Patent Document 2: RP-191971, Revised WID: New Radio Access Technology, 3GPP TSG RAN Meeting #85
Non-Patent Document 3: RP-190224, Revised SID: Study on NR V2X, 3GPP TSG RAN Meeting #83
Non-Patent Document 4: RP-200129, Revised WID on 5G V2X with NR sidelink, 3GPP TSG RAN Meeting #87-e
Non-Patent Document 5: RP-202846, Revised WID on NR Sidelink enhancement, 3GPP TSG RAN Meeting #90-e
Non-Patent Document 6: RP-222806, Revised WID: NR sidelink evolution, 3GPP TSG RAN Meeting #98-e

### SUMMARY OF THE INVENTION

In order to solve at least part of the above problems, the present invention provides a method performed by a user equipment and a user equipment. When a resource subset for resource selection is determined for one PSSCH transmission in a resource pool configured with interlace-based PSSCH transmission, each candidate resource in a corresponding full set of candidate resources is defined as the same set of subchannels in each RB set of any number of contiguous RB sets in the resource pool, so that the full set of candidate resources as large as possible is obtained under the premise of satisfying a resource reservation signaling limitation, thereby increasing the flexibility of resource selection and reducing the probability of resource collision between different UEs.

According to the present invention, a method performed by a user equipment is provided. The method comprises: determining a resource subset which can be used for PSSCH transmission of a full set of candidate resources in a resource pool configured with interlace-based PSSCH transmission, and reporting the resource subset to a higher layer entity, wherein each candidate resource in the full set of candidate resources corresponds to the same non-empty set of subchannels in each RB set of one or more contiguous RB sets in the resource pool.

Furthermore, according to the present invention, a user equipment is provided, comprising: a processor; and a memory storing instructions, wherein the instructions, when run by the processor, perform the above method.

Therefore, the present invention provides a method. When a resource subset for resource selection is determined for one PSSCH transmission in a resource pool configured with interlace-based PSSCH transmission, each candidate resource in a corresponding full set of candidate resources is defined as the same set of subchannels in each RB set of any number of contiguous RB sets in the resource pool, so that the full set of candidate resources as large as possible is obtained under the premise of satisfying a resource reservation signaling limitation, thereby increasing the flexibility of resource selection and reducing the probability of resource collision between different UEs.

### BRIEF DESCRIPTION OF THE DRAWINGS

The above and other features of the present invention will be more apparent from the following detailed description in combination with the accompanying drawings, in which:

FIG. 1 shows a flowchart corresponding to a method performed by a user equipment according to Embodiment 1 of the present invention.

FIG. 2 shows a flowchart corresponding to a method performed by a user equipment according to Embodiment 2 of the present invention.

FIG. 3 shows a flowchart corresponding to a method performed by a user equipment according to Embodiment 3 of the present invention.

FIG. 4 shows a block diagram of a user equipment according to the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to prevent obscuring the understanding of the present invention.

A plurality of embodiments according to the present invention will be specifically described below using 5G (also referred to as NR or 5G NR) wireless communication system specifications formulated by the 3GPP and subsequent evolved versions thereof (e.g., 5G Advanced) as an exemplary application environment. However, it should be noted that the present invention is not limited to the following embodiments, but rather is applicable to many other wireless communication systems, such as wireless communication systems later than 5G, or 4G mobile communication systems earlier than 5G, e.g., Long Term Evolution (LTE), LTE-Advanced, LTE-Advanced Pro, etc.

The terms given in the present invention may be named differently in different wireless communication systems, but unified terms are used in the present invention. When applied to a specific system, the terms may be replaced with terms used in the corresponding system.

Unless otherwise specified, in all embodiments and implementations of the present invention:
“Node” and “communication node” may be interchangeable.
The “node” may refer to a UE, or a network node (e.g., a base station), or a communication node in another form.
“Base station” may refer to a 4G base station, e.g., an eNB (E-UTRAN Node B, wherein E-UTRAN stands for Evolved Universal Terrestrial Radio Access Network); or a 5G base station, e.g., a gNB (a node that provides NR user plane and control plane protocol terminations to a UE and is connected to a 5G core network via an NG interface), or an ng-eNB (a node that provides E-UTRA user plane and control plane protocol terminations to a UE and is connected to a 5G core network via an NG interface, wherein E-UTRA stands for Evolved Universal Terrestrial Radio Access); or a base station in another form.
“Lower layer(s)” may refer to one or more protocol layers or protocol sublayers below a reference protocol layer or a reference protocol sublayer in a specific protocol stack. For example, if the reference protocol layer or the reference protocol sublayer is an RRC layer, then “lower layer(s)” may refer to a MAC layer, and/or a physical layer; in another example, if the reference protocol layer or the reference protocol sublayer is a MAC layer, then “lower layer(s)” may refer to a physical layer. Unless otherwise specified, the reference protocol layer or the reference protocol sublayer is a MAC layer. A “lower layer” may also be referred to as a “low layer” if this causes no ambiguity.
“Higher layer(s)” or “upper layer(s)” may be one or more protocol layers or protocol sublayers above a reference protocol layer or a reference protocol sublayer in a specific protocol stack, for example, an access stratum protocol stack. For example, if the reference protocol layer or the reference protocol sublayer is a physical layer (also referred to as “Layer 1”), “higher layer(s)” may refer to a Medium Access Control (MAC) layer, and/or a Radio Link Control (RLC) layer, and/or a Packet Data Convergence Protocol (PDCP) layer, and/or a PC5-RRC (Radio Resource Control) layer, and/or a PC5-S layer, and/or an RRC layer, and/or another protocol layer or protocol sublayer. Unless otherwise specified, the reference protocol layer or the reference protocol sublayer is a physical layer. A “higher layer” may also be referred to as a “high layer” if this causes no ambiguity.
“Signaling” may refer to signaling of a physical layer, or signaling of a higher layer.
“Configure” may mean that in a communication node (e.g., a UE), a protocol layer (e.g., an RRC layer) entity provides configuration information to another protocol layer (e.g., a physical layer) entity.
“Configure” may mean that a protocol layer (e.g., an RRC layer) entity of a communication node (e.g., a base station) provides configuration information to a peer protocol layer entity of another communication node (e.g., a UE) (e.g., transmission, from the base station to the UE, of RRC signaling in which the configuration information is included, or transmission, from a UE-A to a UE-B, of PC5-RRC signaling in which the configuration information is included).
“Pre-configure” may mean that corresponding configuration information is preset in a specific storage location in a communication node (e.g., a UE), or corresponding configuration information is preset in a specific storage location accessible by a UE.
“(Pre-)configure” may refer to “configure or pre-configure”.
“Number” may refer to “total number”. For example, “the number of subchannels in a resource pool” may refer to the total number of subchannels in the resource pool.
A sequence “t₀, t₁, . . . , t_{N-1}” may be used to represent the case that N is greater than or equal to 1. For example, N=1. Correspondingly, the sequence is “t₀”. In another example, N=2. Correspondingly, the sequence is “t₀, t₁”.
Elements in a time sequence (e.g., denoted as t₀, t₁, . . . , t_{N-1}) or a corresponding set (e.g., denoted as {t₀, t₁, . . . , t_{N-1}}) may appear in chronological order, for example, a time corresponding to t₀ is earlier than (or not later than) a time corresponding to t₁, a time corresponding to t₁ is earlier than (or not later than) a time corresponding to t₂, etc.
μ may represent a subcarrier spacing configuration, for example μ=0. Δf may represent a corresponding subcarrier spacing (SCS). For example, μ=0 corresponds to Δf=15 kHz.
A “symbol” may refer to an Orthogonal Frequency Division Multiplexing (OFDM) symbol.
A resource may correspond to one or more of the following:
   One or more parameters in the time domain. For example, a starting symbol of the resource, a starting slot of the resource, the number of symbols occupied by the resource, or the number of slots occupied by the resource.
   One or more parameters in the frequency domain. For example, a starting subchannel of the resource, a starting resource block (RB) of the resource, a starting subcarrier of the resource, the number of subchannels occupied by the resource, the number of RBs occupied by the resource, or the number of subcarriers occupied by the resource.
   One or more parameters in the code domain. For example, a cyclic shift value corresponding to the resource or a corresponding cyclic shift index, or a cyclic shift pair value corresponding to the resource or a corresponding cyclic shift pair index.
   One or more parameters in the spatial domain. For example, a layer corresponding to the resource, wherein a “layer” may refer to a multiple input multiple output (MIMO) layer.
A “layer” may refer to one of one or more layers to which a transport block (TB) is mapped in spatial multiplexing. The mapping may also be considered as a mapping of a codeword corresponding to the TB to the one or more layers.
An “RB” may refer to a physical resource block (PRB), a virtual resource block (VRB), a common resource block (CRB), or an interlaced resource block (IRB).
“Numbering” and “indexing” are interchangeable. For example, the number of an RB may also be referred to as the index of the RB. In another example, “numbering an RB as 0” may also be expressed as “indexing an RB as 0”.
An RB represented by a CRB index may also be represented by a corresponding PRB index, and vice versa.
The indexes of elements in a sequence (or an array, or a list, or an ordered set, or the like) may start from 0. For example, the first RB of an RB set may be referred to as RB 0 of the RB set.
Bits in a bitmap (or referred to as a “bit string”) that includes

$${N}_{BM}^{ref}$$

bits may be sequentially indexed as 0, 1, . . . , and

$${N}_{BM}^{ref} - 1$$

in an order from a most significant bit (MSB) to a least significant bit (LSB or m an order from the LSB to the MSB), wherein

$${N}_{BM}^{ref}$$

may be referred to as the size (or “the length”) of the bitmap, and the MSB may be the leftmost bit of the bitmap, or the rightmost bit of the bitmap.
An object (e.g., a subcarrier, a slot, or a cyclic shift) may be represented by an index thereof, wherein the index may be an index within a set. For example, each element in the set of subchannels

$${SC}_{ref} = \{ {sc}_{0}^{ref} , {sc}_{1}^{ref} , {sc}_{2}^{ref} , {sc}_{3}^{ref} , {sc}_{4}^{ref} \}$$

may represent one subchannel, and/or a subchannel index corresponding to the subchannel.
In signaling, an object may be indicated by means of the index of the object.
If an object is mentioned without the number thereof being specified, then the number of the object may be singular or plural. For example, in the expression “performing transmission(s) on a channel”, the “transmission(s)” may correspond to one transmission, or a plurality of transmissions.
Δ(x₁, x₂) may represent an offset between x₁ and x₂, wherein x₁ and x₂ may be two parameters (or variables) that can be compared, or two possible values of one parameter (or variable). For example, if x₁ and x₂ represent two slots in one resource pool, Δ(x₁, x₂) may be defined as a difference between a physical slot index corresponding to the slot x₂ and a physical slot index corresponding to the slot x₁, or be defined as a difference between a logical slot index corresponding to the slot x₂ and a logical slot index corresponding to the slot x₁.
The “offset between x₁ and x₂” may also be referred to as an offset of x₂ with respect to x₁ or an offset of x₂ relative to x₁.
The “offset between x₁ and x₂” may also be referred to as an offset from x₁ to x₂.
If Δ(x₁, x₂)=D, then x₂ may be denoted as x₂=ADD(x₁, D).
If Δ(x₁, x₂)=D, then x₁ may be denoted as x₁=SUBTRACT(x₂, D).
An offset between two subcarriers may be an offset between center frequencies of the two subcarriers.
A modulo operation may be defined as r≡a mod N, wherein
   r is a remainder;
   a=N×q+r, wherein q=└a/N┘. q may be referred to as an integer quotient of a and N.

$$0 \leq r < \vert N \vert .$$

A round operation may be denoted as b=round(a), wherein b may be defined as the integer closest to a. If there are two integers closest to a, b may be defined as the larger of the two integers, or as the smaller of the two integers.
Sidelink control information (SCI) may refer to 1^{st}-stage SCI and/or 2^{nd}-stage SCI.
SL refers to NR SL.
A “sidelink” may be an NR sidelink.
A “carrier” may be a sidelink carrier.
A “bandwidth part” may be a sidelink bandwidth part.
A “resource pool” may be a sidelink resource pool.
A “sidelink slot” may refer to a slot (pre-)configured with a sidelink resource (e.g., a slot in a resource pool). The “sidelink resource” may or may not include a resource for a specific purpose. The “resource for a specific purpose” may be a resource for a synchronization procedure, for example, a resource for transmitting an S-SS/Physical Sidelink Broadcast Channel or Sidelink-Synchronization Signal/Physical Sidelink Broadcast Channel (S-SS/PSBCH) block.
A “physical slot” may refer to a slot belonging to a certain set of physical slots, wherein the set of physical slots may be all of the slots in a continuous period of time (e.g., a frame period having a duration of 1024 frames). Physical slots in the set of physical slots may be sequentially indexed as 0, 1, . . . in chronological order.
A “logical slot” may refer to a slot belonging to a set of slots of a certain resource pool, wherein the set of slots may be all of the slots belonging to the resource pool in a continuous period of time (e.g., a frame period having a duration of 1024 frames); logical slots in the set of slots may be sequentially indexed as 0, 1, . . . in chronological order.
A “logical slot” may refer to a slot that may be (pre-)configured to belong to a set of slots of a certain resource pool.
A “sidelink slot” may refer to a slot that belongs to a set of slots of a certain resource pool.
A “sidelink slot” may refer to a slot that may be (pre-)configured to belong to a set of slots of a certain resource pool.
A sidelink transmission which multiplexes a physical sidelink shared channel (PSSCH) and a physical sidelink control channel (PSCCH) associated therewith in the same resource (e.g., a number of contiguous symbols in a sidelink slot in the time domain, and a number of contiguous subchannels in the frequency domain) may be referred to as a “PSCCH/PSSCH transmission” (or a PSSCH/PSCCH transmission).
In the time domain, a “frame” (also referred to as a “radio frame”) may be a system frame or a direct frame. A frame number period (e.g., denoted as T_{FNP}) may be a value of a pre-defined or (pre-)configured parameter, or may be determined based on a value of one or more pre-defined or (pre-)configured parameters, e.g., T_{FNP}=1024 frames. The duration of each frame may be T_{f}=10 milliseconds, in which 10 subframes may be included, wherein the duration of each subframe is T_{sf}=1 millisecond. Each subframe may include

$${N}_{slot}^{subframe , μ}$$

slots, e.g.

$${N}_{slot}^{subframe , μ} = {2}^{μ} .$$

The index of a slot in a subframe may be denoted as

$${n}_{s}^{μ} ( {n}_{s}^{μ} ∈ \{ 0 , 1 , … , {N}_{slot}^{subframe , μ} - 1 \} ) .$$

The index of a slot in a frame may be denoted as

$${n}_{s , f}^{μ} ( {n}_{s , f}^{μ} ∈ \{ 0 , 1 , … , {N}_{slot}^{frame , μ} - 1 \} ) ,$$

wherein

$${N}_{slot}^{frame , μ}$$

may be equal to 10·2^{μ}. The index of a slot in a frame number period may be denoted as

$${n}_{s , f , p}^{μ} ( {n}_{s , f , p}^{μ} ∈ \{ 0 , 1 , … , {N}_{slot}^{FNP , μ} - 1 \} ) ,$$

wherein

$${N}_{slot}^{FNP , μ}$$

may be equal to

$${T}_{FNP} \cdot {N}_{slot}^{frame , μ} ( e . g . , 1024 \cdot ( 10 \cdot {2}^{μ} ) ) .$$

“Sidelink grant” may refer to “sidelink dynamic grant” or “sidelink configured grant”.
“Sidelink dynamic grant” and “dynamic sidelink grant” are interchangeable.
“Sidelink configured grant” and “configured sidelink grant” are interchangeable.
“Type 1 sidelink configured grant” and “sidelink configured grant type 1” are interchangeable.
“Type 2 sidelink configured grant” and “sidelink configured grant type 2” are interchangeable.
“Channel” refers to a shared spectrum channel. For example, a shared spectrum channel having a bandwidth of 20 MHz on which a “channel access procedure” may be performed.
“Physical sidelink feedback channel (PSFCH) resource” (PSFCH resource) may be replaced with “PSFCH transmission resource” or “PSFCH transmission occasion resource”.
A sidelink identity (sidelink ID, SL ID) may be a layer 1 sidelink ID or a layer 2 sidelink ID.
A priority (or priority level) may correspond to a priority value. For example, one priority corresponds to a priority value of 0, and another priority corresponds to a priority value of 1.
One priority may correspond to one priority value at each of one or more protocol layers (or protocol sublayers). Corresponding priority values at different protocol layers (or protocol sublayers) may be equal or unequal. For example, one priority may correspond to a priority value of 0 at a physical layer, and a priority value of 1 at a higher layer. In another example, another priority may correspond to a priority value of 1 at a physical layer and a priority value of 2 at a higher layer.
The relationship between the priority order and the corresponding priority value may be that: as the priority value increases, the priority (or referred to as “priority order”) decreases. For example, if priority values corresponding to priorities associated with a first sidelink transmission and a second sidelink transmission are 0 and 1, respectively, a priority of the first sidelink transmission is higher than a priority of the second sidelink transmission.
The relationship between the priority order and the corresponding priority value may be that: as the priority value increases, the priority (or referred to as “priority order”) increases. For example, if priority values corresponding to priorities associated with a first sidelink transmission and a second sidelink transmission are 0 and 1, respectively, a priority of the first sidelink transmission is lower than a priority of the second sidelink transmission.

5G is capable of operating in both a licensed spectrum (e.g., part or all of 3300 MHz to 3800 MHz) and an unlicensed spectrum (e.g., part or all of 5150 MHz to 5925 MHz, or part or all of 5925 MHz to 7125 MHz, or part or all of 5925 MHz to 6425 MHz).

For an unlicensed spectrum, a node that supports 5G may perform an “operation with shared spectrum channel access”, for example, a “channel access procedure” (also referred to as single-channel access procedure, or referred to as channel access procedure for transmission(s) on a single channel) is performed on a “shared-spectrum channel” (also referred to as “channel” for short), or a “multi-channel access procedure” (also referred to as a channel access procedure for transmission(s) on multiple channels) is performed on a plurality of shared spectrum channels, so as to assess whether part or all of the corresponding one or more shared spectrum channels can be used to perform (one or more) transmission(s) (e.g., downlink transmission, uplink transmission, or sidelink transmission), wherein one shared spectrum channel may include a number of contiguous RBs. In the present invention, unless otherwise specified, a “channel access procedure” (or “channel access”) may correspond to a channel access procedure for single-channel transmission or a channel access procedure for multi-channel transmission. A result of a channel access procedure may be “success” (also referred to as “channel access success”) or “failure” (also referred to as “channel access failure”).

The operation of assessing whether the one or more shared spectrum channels can be used to perform one or more transmission(s) may be referred to as clear channel assessment (CCA). Such a mechanism of performing CCA before using one or more shared spectrum channels may be referred to as listen before talk (LBT). Correspondingly, each of the one or more shared spectrum channels may be referred to as an “LBT channel”. Correspondingly, “channel access success” may be referred to as “LBT success”, and “channel access failure” may be referred to as “LBT failure”. Whether a communication node needs to perform CCA (also referred to as “needs to perform LBT”), and a specific procedure of the CCA, may be related to the regulations of the country and/or region in which the communication node is located.

One or more “sensing” operations may be performed on a channel during channel access, wherein the state of the channel (e.g., “busy”; or, e.g., “idle”) may be determined in each sensing operation. For example, within a sensing slot duration Tₛₗ, if a duration in which power detected on the channel (e.g., denoted as X_{detected}) is less than (or, less than or equal to) a power detection threshold (e.g., denoted as Xₜₕᵣₑₛₕ) is at least T_{sl,thresh}, then it can be considered that the channel is idle within the sensing slot duration Tₛₗ; otherwise, it can be considered that the channel is busy within the sensing slot duration Tₛₗ. T_{sl,thresh} may be a pre-defined or configured value, e.g., T_{sl,thresh}=4 ρs. The sensing slot duration Tₛₗ may be a pre-defined or configured value, e.g., Tₛₗ=9 μs.

In a channel access procedure for single-channel transmission performed for one or more intended transmissions, whether part or all of the one or more intended transmissions can be performed can be determined, and/or the result of the single-channel access procedure can be determined, on the basis of one or more “sensing” operations on a channel (e.g., denoted as ch₀) within a first channel access duration, with the duration of each operation being a second channel access duration (e.g., this may correspond to a sensing slot duration Tₛₗ), and based on the state (e.g., “idle”; or e.g., “busy”) of the channel ch₀ determined in each “sensing” operation. For example, if, within the first channel access duration, the number of times which the channel ch₀ is consecutively determined to be “idle” reaches (or exceeds) a pre-defined or configured threshold, then the one or more intended transmissions may be performed, and/or the channel ch₀ may be considered to have been successfully accessed (correspondingly, the result of the channel access procedure is “success”, also referred to as “channel access success”, and also referred to as “LBT success”); otherwise, the one or more intended transmissions cannot be performed, and/or it may be considered that the channel ch₀ cannot be accessed (correspondingly, the result of the channel access procedure is “failure”, also referred to as “channel access failure”, and also referred to as “LBT failure”).

In a channel access procedure for multi-channel transmission performed for one or more intended transmissions, channel access may be performed on part or all of the channels in a set of channels, respectively, and based on channel access result(s) corresponding to one or more of the channels, respectively, whether part or all of the one or more intended transmissions may be performed is determined, and/or the result of the multi-channel access procedure is determined (e.g., the result may be “success”, also referred to as “channel access success”, and also referred to as “LBT success”; or, the result may be “failure”, also referred to as “channel access failure”, and also referred to as “LBT failure”).

After a channel access procedure is performed, (one or more) transmissions performed on the corresponding (one or more) channel(s) may be referred to as “channel occupancy” (CO), and a corresponding duration may be referred to as a “channel occupancy time” (COT). A COT may be shared between one or more communication nodes, and correspondingly, the time corresponding to the COT may include the duration of (one or more) transmissions performed by the one or more communication nodes on the corresponding (one or more) channels, and optionally, the time corresponding to a transmission gap between the transmissions (e.g., when the duration of the transmission gap is less than or equal to 25 us). A COT may not exceed a pre-defined or configured maximum value (e.g., referred to as a maximum COT, or simply referred to as a MCOT).

One shared spectrum channel may correspond to one carrier (e.g., denoted as c₀), or one part of the carrier c₀. For example, the carrier c₀ has a bandwidth of 20 MHz, and correspondingly, one shared spectrum channel may correspond to the carrier c₀. In another example, the carrier c₀ has a bandwidth of 40 MHz, and correspondingly, one shared spectrum channel may correspond to the lower-frequency 20-MHz portion of the carrier c₀, and another shared spectrum channel may correspond to the other 20-MHz portion (i.e., the higher-frequency 20-MHz portion) of the carrier c₀.

More generally, the carrier c₀ may include

$${N}_{CH}^{c , 0}$$

channels (e.g.,

$${N}_{CH}^{c , 0}$$

contiguous channels), for example, in ascending order of frequency, denoted as

$${ch}_{0}^{c , 0} , {ch}_{1}^{c , 0} , … , and {ch}_{{N}_{ch}^{c , 0} - 1}$$

respectively, and the corresponding set of channels may be denoted as CH_{c,0}=

$$\{ {ch}_{0}^{c , 0} , {ch}_{1}^{c , 0} , … , {ch}_{{N}_{CH}^{c , 0} - 1}^{c , 0} \} ,$$

wherein

$${N}_{CH}^{c , 0}$$

may be an integer greater than or equal to 1. On the other hand, the carrier c₀ may include

$${N}_{RS}^{c , 0}$$

“RB sets” (e.g.,

$${N}_{RS}^{c , 0}$$

contiguous RB sets), for example, in ascending order of frequency, denoted as

$${rs}_{0}^{c , 0} , {rs}_{1}^{c , 0} , … , and {rs}_{{N}_{RS}^{c , 0} - 1}^{c , 0}$$

respectively, and the corresponding set of RB sets may be denoted as

$${RS}_{c , 0} = \{ {rs}_{0}^{c , 0} , {rs}_{1}^{c , 0} , … , {rs}_{{N}_{RS}^{c , 0} - 1}^{c , 0} \} ,$$

wherein each RB set may correspond to a number of contiguous RBs;

$${N}_{RS}^{c , 0}$$

may be an integer greater than or equal to 1; for

$$i ∈ \{ 0 , 1 , … , {N}_{RS}^{c , 0} - 1 \} ,$$

the lowest-indexed CRB, the highest-indexed CRB, and the number of RBs of the RB set

$${rs}_{i}^{c , 0}$$

may be denoted as

$${N}_{start}^{c , 0 , rs , i} , {N}_{end}^{c , 0 , rs , i} , and {N}_{size}^{c , 0 , rs , i}$$

respectively, wherein

$${N}_{size}^{c , 0 , rs , i}$$

may be equal to

$${N}_{end}^{c , 0 , rs , i} - {N}_{start}^{c , 0 , rs , i} + 1 .$$

There may be a guard band (e.g., referred to as an “intra-cell guard band”) between two adjacent RB sets, wherein each intra-cell guard band may consist of a number of contiguous RBs (each such RB may be referred to as one “guard band RB”). For example, in the carrier c₀, there may be

$${N}_{GB}^{c , 0} = {N}_{RS}^{c , 0} - 1$$

intra-cell guard bands used to separate the

$${N}_{RS}^{c , 0}$$

RB sets, e.g., denoted as

$${gb}_{0}^{c , 0} , {gb}_{1}^{c , 0} , … , and {gb}_{{N}_{GB}^{c , 0} - 1}^{c , 0}$$

respectively, and the corresponding set of intra-cell guard bands may be denoted as

$${GB}_{c , 0} = \{ {gb}_{0}^{c , 0} , {gb}_{1}^{c , 0} , … , {gb}_{{N}_{GB}^{c , 0} - 1}^{c , 0} \} ,$$

wherein for

$$i ∈ \{ 0 , 1 , … , {N}_{GB}^{c , 0} - 1 \} , {gb}_{i}^{c , 0}$$

may be used to separate the RB set

$${rs}_{i}^{c , 0}$$

### and the RB set

$${rs}_{i + 1}^{c , 0} ;$$

the lowest-indexed CRB, the highest-indexed CRB, and the number of RBs of

$${gb}_{i}^{c , 0}$$

may be denoted as

$${N}_{s t a r t}^{c , 0 , gb , i} , {N}_{e n d}^{c , 0 , gb , i} , and {N}_{s i z e}^{c , 0 , gb , i}$$

respectively, wherein

$${N}_{s i z e}^{c , 0 , gb , i}$$

mat be equal to

$${N}_{e n d}^{c , 0 , gb , i} - {N}_{s t a r t}^{c , 0 , gb , i} + 1 .$$

Specifically, for example, the carrier c₀ has a bandwidth of 40 MHz, and correspondingly, for a 15-kHz SCS, the carrier c₀ may include 216 contiguous RBs (e.g., the CRB indexes thereof being denoted as 0, 1, . . . , 215 respectively), and the 216 RBs may be classified into 3 subsets, which correspond to an RB set

$${rs}_{0}^{c , 0}$$

(wherein

$${N}_{s t a r t}^{c , 0 , rs , 0} = 0 , {N}_{e n d}^{c , 0 , rs , 0} = 104 , and {N}_{s i z e}^{c , 0 , rs , 0} = 105 ) ,$$

an intra-cell guard band

$$g {b}_{0}^{c , 0}$$

(wherein

$${N}_{start}^{c , 0 , gb , 0} = 105 , {N}_{e n d}^{c , 0 , gb , 0} = 110 , and {N}_{s i z e}^{c , 0 , gb , 0} = 6 ) ,$$

and another RB set

$$r {s}_{1}^{c , 0}$$

(wherein

$${N}_{s t a r t}^{c , 0 , rs , 1} = 111 , {N}_{e n d}^{c , 0 , rs , 1} = 215 , and {N}_{s i z e}^{c , 0 , rs , 1} = 105 ) ,$$

respectively.

For i∈

$$\{ 0 , 1 , … , {N}_{G B}^{c , 0} - 1 \} , if {gb}_{i}^{c , 0}$$

is an empty set, then it may be considered that there is no corresponding intra-cell guard band. If, for i=0, 1, . . . , and

$${N}_{GB}^{c , 0} - 1 , g {b}_{i}^{c , 0}$$

is invariably an empty set, then it may be considered that there is not any intra-cell guard band between any two adjacent RB sets of the carrier c₀.

The

$${N}_{CH}^{c , 0}$$

may be equal to the

$${N}_{RS}^{c , 0} ,$$

and correspondingly, for

$$i ∈ \{ 0 , 1 , … , {N}_{RS}^{c , 0} - 1 \} ,$$

### the RB set

$$r {s}_{i}^{c , 0}$$

may correspond to a number of contiguous RBs within the bandwidth of the channel

$$c {h}_{i}^{c , 0} ;$$

the

$$r {s}_{i}^{c , 0}$$

may be referred to as the RB set corresponding to the

$$c {h}_{i}^{c , 0} ;$$

the

$$c {h}_{i}^{c , 0}$$

may be referred to as the channel corresponding to the

$$r {s}_{i}^{c , 0} ;$$

optionally, if

$$r {s}_{i}^{c , 0}$$

is in a resource pool, then it can be considered that the

$$c {h}_{i}^{c , 0}$$

is in the resource pool; optionally, if

$$c {h}_{i}^{c , 0}$$

is in a resource pool, then it can be considered that the

$$r {s}_{i}^{c , 0}$$

is in the resource pool; optionally, if a resource pool includes the

$${rs}_{i}^{c , 0} ,$$

then it can be considered that the resource pool includes the

$${ch}_{i}^{c , 0} ;$$

and optionally, if a resource pool includes the

$$c {h}_{i}^{c , 0} ,$$

then it can be considered that the resource pool includes the

$${rs}_{i}^{c , 0} .$$

A set of RB sets corresponding to a set of channels may be defined as a set consisting of RB sets corresponding to all of the channels in the set of channels, respectively.

A set of channels corresponding to a set of RB sets may be defined as a set consisting of channels corresponding to all of the RB sets in the set of RB sets, respectively.

One bandwidth part (BWP) (e.g., denoted as b₀) in the carrier c₀ may include

$${N}_{CH}^{b , 0}$$

channels (e.g.,

$${N}_{CH}^{b , 0}$$

contiguous channels), e.g., denoted as

$${ch}_{0}^{b , 0} , {ch}_{1}^{b , 0} , … , and {ch}_{{N}_{CH}^{b , 0} - 1}^{b , 0} ,$$

respectively, and the corresponding set of channels may be denoted as

$${CH}_{b , 0} = \{ {ch}_{0}^{b , 0} , {ch}_{1}^{b , 0} , … , {ch}_{{N}_{CH}^{b , 0} - 1}^{b , 0} \} ,$$

wherein

$${N}_{CH}^{b , 0}$$

may satisfy

$$1 \leq {N}_{CH}^{b , 0} \leq {N}_{CH}^{c , 0} ,$$

and the set CH_{b,0} may be a subset of the set CH_{c,0}. On the other hand, the bandwidth part b₀ may include

$${N}_{RS}^{b , 0} RB$$

sets (e.g.,

$${N}_{RS}^{b , 0}$$

contiguous RB sets), e.g., denoted as

$${rs}_{0}^{b , 0} , {rs}_{1}^{b , 0} , … , and {rs}_{{N}_{RS}^{b , 0} - 1}^{b , 0} ,$$

respectively, and the corresponding set of RB sets may be denoted as

$${RS}_{b , 0} = \{ {rs}_{0}^{b , 0} , {rs}_{1}^{b , 0} , … , {rs}_{{N}_{RS}^{b , 0} - 1}^{b , 0} \} ,$$

wherein

$${N}_{RS}^{b , 0}$$

may satisfy

$$1 \leq {N}_{RS}^{b , 0} \leq {N}_{RS}^{c , 0} ,$$

and the set RS_{b,0} may be a subset of the set RS_{c,0}. For i∈

$$\{ 0 , 1 , … , {N}_{RS}^{b , 0} - 1 \} ,$$

the lowest-indexed CRB, the highest-indexed CRB, and the number of RBs of

$$r {s}_{i}^{b , 0}$$

may be denote as

$${N}_{s t a r t}^{b , 0 , rs , i} ,$$

$${N}_{e n d}^{b , 0 , rs , i} and {N}_{s i z e}^{b , 0 , rs , i} ,$$

respectively, wherein

$${N}_{s i z e}^{b , 0 , rs , i}$$

may be equal to

$${N}_{e n d}^{b , 0 , rs , i} - {N}_{s t a r t}^{b , 0 , rs , i} + 1.$$

The lowest-indexed CRB (e.g., denoted as

$${N}_{s t a r t}^{b , 0} )$$

and the number of RBs (e.g., denoted as

$${N}_{s i z e}^{b , 0} )$$

of the bandwidth part b₀ may be equal to

$${N}_{s t a r t}^{b , 0 , rs , 0} and {N}_{e n d}^{b , 0 , rs , {N}_{RS}^{b , 0} - 1} - {N}_{s t a r t}^{b , 0 , rs , 0} + 1 ,$$

respectively.

$${N}_{CH}^{b , 0}$$

may be equal to

$${N}_{RS}^{b , 0} .$$

### Correspondingly, for

$$i ∈ \{ 0 , 1 , … , {N}_{CH}^{b , 0} - 1 \} , c {h}_{i}^{b , 0}$$

may be a channel corresponding to

$$r {s}_{i}^{b , 0} , and {rs}_{i}^{b , 0}$$

may be an RB set corresponding to

$$c {h}_{i}^{b , 0} .$$

A subcarrier spacing configuration of the bandwidth part b₀ may be denoted as μ_{b,0}.

One or more resource pools may be defined or (pre-)configured in the bandwidth part b₀.

One resource pool (e.g., denoted as eⱼ) in the bandwidth part b₀ may correspond to one set of slots in the time domain, e.g., denoted as

$${T}_{RP}^{e , j} = \{ {t}_{0}^{e , j} , {t}_{1}^{e , j} , … , {t}_{{N}_{T}^{e , j} - 1}^{e , j} \} ,$$

wherein

$${N}_{T}^{e , j}$$

may be an integer greater than or equal to 1. The slots in the set

$${T}_{RP}^{e , j}$$

may be some or all slots in a system frame number (SFN) or direct frame number (DFN) period (e.g., 10240 milliseconds).

The resource pool eⱼ may include

$${N}_{CH}^{e , j}$$

channels (e.g.,

$${N}_{CH}^{e , j}$$

contiguous channels), e.g., denoted as

$$c {h}_{0}^{e , j} , c {h}_{1}^{e , j} , … , and {ch}_{{N}_{CH}^{e , {j}_{- 1}}}^{e , j} ,$$

respectively, and the corresponding set of channels may be denoted as

$${CH}_{e , j} = \{ c {h}_{0}^{e , j} , {ch}_{1}^{e , j} , … , {ch}_{{N}_{CH}^{e , {j}_{- 1}}}^{e , j} \} ,$$

wherein

$${N}_{CH}^{e , j}$$

may satisfy

$$1 \leq {N}_{CH}^{e , j} \leq {N}_{CH}^{b , 0} ,$$

and the set CH_{e,j} may be a subset of the set CH_{b,0}. On the other hand, the resource pool eⱼ may include

$${N}_{RS}^{e , j} RB$$

sets (e.g.,

$${N}_{RS}^{e , j}$$

contiguous RB sets), e.g., denoted as

$$r {s}_{0}^{e , j} , r {s}_{1}^{e , j} , … , and {rs}_{{N}_{R S}^{e , j} - 1}^{e , j} ,$$

respectively, and the corresponding set of RB sets may be denoted as

$$R {S}_{e , j} = \{ {rs}_{0}^{e , j} , {rs}_{1}^{e , j} , … , {rs}_{{N}_{RS}^{e , j} - 1}^{e , j} \} ,$$

wherein

$${N}_{RS}^{e , j}$$

may satisfy

$$1 \leq {N}_{R S}^{e , j} \leq {N}_{RS}^{b , 0} ,$$

and the set RS_{e,j} may be a subset of the set RS_{b,0}. For

$$i ∈ \{ 0 , 1 , … , {N}_{R S}^{e , j} - 1 \} ,$$

the lowest-indexed CRB, the highest-indexed CRB, and the number of RBs of

$$r {s}_{i}^{e , j}$$

may be denoted as

$${N}_{start}^{e , j , rs , i} , {N}_{end}^{e , j , rs , i} , and {N}_{size}^{e , j , rs , i} ,$$

respectively, wherein,

$${N}_{s i z e}^{e , j , rs , i}$$

may be denoted as

$${N}_{end}^{e , j , rs , i} - {N}_{start}^{e , j , rs , i} + 1 .$$

The lowest-indexed CRB (e.g., denoted as

$${N}_{start}^{e , j} )$$

and the number of RBs (e.g., denoted as

$${N}_{size}^{e , j} )$$

of the resource pool eⱼ may be equal to

$${N}_{start}^{e , j , rs , 0} and {N}_{end}^{e , j , rs , {N}_{RS}^{e , j} - 1} - {N}_{start}^{e , j , rs , 0} + 1 ,$$

respectively.

$${N}_{CH}^{e , j}$$

may be equal to

$${N}_{RS}^{e , j} .$$

### Correspondingly, for

$$i ∈ \{ 0 , 1 , … , {N}_{CH}^{e , j} - 1 \} , {ch}_{i}^{e , j}$$

may be a channel corresponding to

$${rs}_{i}^{e , j} , and {rs}_{i}^{e , j}$$

may be an RB set corresponding to

$${ch}_{i}^{e , j} .$$

For an unlicensed spectrum, in order to ensure fair channel sharing between different communication nodes, a certain restriction may be imposed on the power spectral density (PSD) and/or occupied channel bandwidth (OCB) of signal transmission. For example, the maximum PSD cannot exceed 10 dBm/MHz. In another example, when a channel is used, the bandwidth containing 99% of the transmission power must be greater than or equal to a certain percentage (e.g., 80%) of the nominal channel bandwidth. The restriction (if any) may be made and enforced by regulatory authorities. The restrictions (if any) on the PSD and/or the OCB may be different in different countries and/or regions.

One wireless transmission may correspond to one or more “interlaces”, and correspondingly, the wireless transmission may be referred to as one “interlace-based transmission”. For example, M_{INT} (M_{INT}≥1) interlaces (e.g., the corresponding set of interlaces being denoted as I_{ALL}={int₀, int₁, . . . , int_{M}_{_{INT}}₋₁}) may be defined, wherein for m∈{0,1, . . . , M_{INT}−1}, a set consisting of CRBs corresponding to the interlace m∈{0,1, . . . , M_{INT}−1} may be defined as

$${C}_{m}^{I} = \{ m , {M}_{INT} + m , 2 {M}_{INT} + m , 3 {M}_{INT} + m , … \} ,$$

wherein the set

$${C}_{m}^{I}$$

may be an infinite set. One CRB may belong to one of a set

$${C}_{0}^{I} ,$$

a set

$${C}_{0}^{I} , … ,$$

and a set

$${C}_{{M}_{INT} - 1}^{I} .$$

M_{INT} may be a pre-defined or configured parameter value, or may be determined based on one or more pre-defined or configured parameter values. The value of M_{INT} may be related to the subcarrier spacing configuration μ. For example, for μ=0, M_{INT}=10; in another example, for μ=1, M_{INT}=5. The definition of the interlace (and the corresponding interlace-based transmission) may be applicable only to some subcarrier spacing configurations but not to other subcarrier spacing configurations.

One interlace-based transmission including one or more RBs may be referred to as one “interlaced-RB-based transmission” or “interlace RB-based transmission”.

Compared with a contiguous RB-based transmission, an interlace-based transmission may occupy a larger bandwidth when the number of occupied RBs is constant, so that the OCB limitation can be better met.

One RB in one interlace may be referred to as one interlaced resource block (IRB). For example, the IRB index and the PRB index of one RB in the interlace intₘ in the bandwidth part b₀ may be denoted as

$${irb}_{b , 0}^{i n t , m} and {prb}_{b , 0}^{i n t , m} ,$$

respectively, and the corresponding CRB index may be denoted as

$${crb}_{b , 0}^{i n t , m} ,$$

wherein

$${crb}_{b , 0}^{i n t , m} , {irb}_{b , 0}^{i n t , m} , and {prb}_{b , 0}^{i n t , m}$$

may satisfy:

$${crb}_{b , 0}^{i n t , m} = {M}_{INT} \cdot {irb}_{b , 0}^{i n t , m} + {N}_{s t a r t}^{b , 0} + ( ( m - {N}_{s t a r t}^{b , 0} ) mod {M}_{INT} )$$

A relationship between

$${crb}_{b , 0}^{i n t , m} and {prb}_{b , 0}^{i n t , m}$$

may be:

$${crb}_{b , 0}^{i n t , m} = {prb}_{b , 0}^{i n t , m} + {N}_{s t a r t}^{b , 0}$$

A relationship between

$${irb}_{b , 0}^{i n t , m} and {prb}_{b , 0}^{i n t , m}$$

may be:

$${prb}_{b , 0}^{i n t , m} = {M}_{INT} \cdot {irb}_{b , 0}^{i n t , m} + ( ( m - {N}_{s t a r t}^{b , 0} ) mod {M}_{INT} )$$

The bandwidth part b₀ may correspond to

$${N}_{INT}^{b , 0}$$

interlaces (e.g.,

$${N}_{INT}^{b , 0}$$

contiguous interlaces). For example, the bandwidth part b₀ may include one or more RBs in each interlace of the

$${N}_{INT}^{b , 0}$$

interlaces.

$${N}_{INT}^{b , 0}$$

may be an integer greater than or equal to 1. The

$${N}_{INT}^{b , 0}$$

interlaces may be denoted as

$${int}_{0}^{b , 0} , {int}_{1}^{b , 0} , … , and {int}_{{N}_{INT}^{b , 0} - 1}^{b , 0} ,$$

respectively, and the corresponding set of interlaces may be denoted as

$${I}_{b , 0} = \{ {int}_{0}^{b , 0} , {int}_{1}^{b , 0} , … , {int}_{{N}_{INT}^{b , 0} - 1}^{b , 0} \} ,$$

wherein

$${N}_{INT}^{b , 0}$$

may satisfy

$$1 \leq {N}_{INT}^{b , 0} \leq {M}_{INT} , e . g . , {N}_{INT}^{b , 0} = {M}_{INT} .$$

The set I_{b,0} may be a subset of the set I_{ALL}. The set I_{b,0} may be equal to the set I_{ALL}.

The resource pool eⱼ may correspond to

$${N}_{INT}^{e , j}$$

interlaces (e.g.,

$${N}_{INT}^{e , j}$$

contiguous interlaces). For example, the resource pool eⱼ may include one or more RBs in each interlace of the

$${N}_{INT}^{e , j}$$

interlaces.

$${N}_{INT}^{e , j}$$

may be an integer greater than or equal to 1. The

$${N}_{INT}^{e , j}$$

interlaces may be denoted as

$${int}_{0}^{e , j} , {int}_{1}^{e , j} , … , and {int}_{{N}_{INT}^{e , j} - 1}^{e , j} ,$$

respectively, and the corresponding set of interlaces may be denoted as

$${I}_{e , j} = \{ {int}_{0}^{e , j} , {int}_{1}^{e , j} , … , {int}_{{N}_{INT}^{e , j} - 1}^{e , j} \} ,$$

wherein

$${N}_{INT}^{e , j}$$

may satisfy

$$1 \leq {N}_{INT}^{e , j} \leq {M}_{INT} , e . g . , {N}_{INT}^{e , j} = {M}_{INT} .$$

The set I_{e,j} may be a subset of the set I_{ALL}. The set I_{e,j} may be equal to the set I_{ALL}.

$${N}_{INT}^{e , j}$$

may be equal to

$${N}_{INT}^{b , 0} ( e . g . , {N}_{INT}^{e , j} = {N}_{INT}^{b , 0} = {M}_{INT} ) .$$

The set I_{e,j} may be equal to the set I_{b,0} (e.g., I_{e,j}=I_{b,0}=I_{ALL}).

The resource pool eⱼ may include

$${N}_{SC}^{e , j}$$

subchannels, wherein one subchannel may correspond to one or more RBs, and

$${N}_{SC}^{e , j}$$

may be an integer greater than or equal to 1. The set consisting of the

$${N}_{SC}^{e , j}$$

subchannels may be denoted as SC_{e,j}.

A plurality of schemes for mapping subchannels in one resource pool to RBs may be defined, wherein each such scheme may be referred to as one “subchannel mapping scheme”. For example, the plurality of schemes are referred to as a “subchannel mapping scheme 1”, a “subchannel mapping scheme 2”, and the like, respectively.

In the subchannel mapping scheme 1, a set of subchannels in one resource pool (e.g., the resource pool eⱼ) may be denoted as

$$S {C}_{e , j} = \{ s {c}_{0}^{e , j} , s {c}_{1}^{e , j} , … , {sc}_{{N}_{SC}^{e , j} - 1}^{e , j} \} ,$$

wherein for

$$k ∈ [ 0 , {N}_{SC}^{e , j} - 1 ] ,$$

the subchannel

$$s {c}_{k}^{e , j}$$

may be mapped to

$${N}_{RB , SC}^{e , j}$$

contiguous PRBs. For example, the corresponding set of PRBs is

$$\{ {prb}_{start}^{e , j} + k \cdot {N}_{RB , SC}^{e , j} + q \vert q = 0 , 1 , … , {N}_{RB , SC}^{e , j} - 1 \} ,$$

wherein

$${prb}_{s t a r t}^{e , j}$$

may be an index of a starting PRB of a starting subchannel in the resource pool eⱼ.

$${N}_{RB , SC}^{e , j}$$

may be an integer greater than or equal to 1.

$${N}_{RB , SC}^{e , j}$$

may be a value of one pre-defined or (pre-)configured parameter. For example, the

$${N}_{RB , SC}^{e , j}$$

may be (pre-)configured by using a parameter sl-SubchannelSize).

$${N}_{RB , SC}^{e , j}$$

may be determined based on a value of one or more pre-defined or (pre-)configured parameters.

$${N}_{SC}^{e , j}$$

may be a value of one pre-defined or (pre-)configured parameter. For example, the

$${N}_{SC}^{e , j}$$

may be (pre-)configured by using a parameter sl-NumSubchannel).

$${N}_{SC}^{e , j}$$

may be determined based on a value of one or more pre-defined or (pre-)configured parameters.
For

$$k ∈ [ 0 , {N}_{SC}^{e , j} - 1 ] ,$$

the subchannel

$${sc}_{k}^{e , j}$$

may include zero, or one or more “guard band RBs”. For example, when a guard band is pre-defined or (pre-)configured in a carrier on which the resource pool eⱼ is located, some subchannels in the resource pool eⱼ may include one or more “guard band RBs”.
For

$$k ∈ [ 0 , {N}_{SC}^{e , j} - 1 ] ,$$

the index k corresponding to the subchannel

$${sc}_{k}^{e , j}$$

may be referred to as a “type 1 subchannel index”. More generally, for any resource pool, if an incrementing index starting from 0 is sequentially allocated to each subchannel in the resource pool in ascending order of starting PRBs of all subchannels in the resource pool, then each such index may be referred to as one “type 1 subchannel index”.

The subchannel mapping scheme 1 (or a contiguous RB-based PSSCH transmission; or a non-interlace RB-based PSSCH transmission; or a contiguous RB-based PSCCH/PSSCH transmission; or a non-interlace RB-based PSCCH/PSSCH transmission) may be applicable to a licensed spectrum.

The subchannel mapping scheme 1 (or a contiguous RB-based PSSCH transmission; or a non-interlace RB-based PSSCH transmission; or a contiguous RB-based PSCCH/PSSCH transmission; or a non-interlace RB-based PSCCH/PSSCH transmission) may be applicable to an operation without shared spectrum channel access.

The subchannel mapping scheme 1 (or a contiguous RB-based PSSCH transmission; or a non-interlace RB-based PSSCH transmission; or a contiguous RB-based PSCCH/PSSCH transmission; or a non-interlace RB-based PSCCH/PSSCH transmission) may be applicable to an unlicensed spectrum.

For an unlicensed spectrum, the subchannel mapping scheme 1 (or a contiguous RB-based PSSCH transmission; or a non-interlace RB-based PSSCH transmission; or a contiguous RB-based PSCCH/PSSCH transmission; or a non-interlace RB-based PSCCH/PSSCH transmission) may be applicable to (or applicable only to) some subcarrier spacing configurations (e.g., a subcarrier spacing configuration 2 and a subcarrier spacing configuration 3; in another example, other subcarrier spacing configurations except for the subcarrier spacing configuration 0 and the subcarrier spacing configuration 1).

The subchannel mapping scheme 1 (or a contiguous RB-based PSSCH transmission; or a non-interlace RB-based PSSCH transmission; or a contiguous RB-based PSCCH/PSSCH transmission; or a non-interlace RB-based PSCCH/PSSCH transmission) may be applicable to an operation with shared spectrum channel access.

For the operation with shared spectrum channel access, the subchannel mapping scheme 1 (or a contiguous RB-based PSSCH transmission; or a non-interlace RB-based PSSCH transmission; or a contiguous RB-based PSCCH/PSSCH transmission; or a non-interlace RB-based PSCCH/PSSCH transmission) may be applicable to (or applicable only to) some subcarrier spacing configurations (e.g., a subcarrier spacing configuration 2 and a subcarrier spacing configuration 3; in another example, other subcarrier spacing configurations except for the subcarrier spacing configuration 0 and the subcarrier spacing configuration 1).

In the subchannel mapping scheme 2,

$${N}_{INT}^{e , j}$$

interlaces (e.g., M_{INT} interlaces in the set I_{ALL} of interlaces) corresponding to one resource pool (e.g., the resource pool eⱼ) may be divided into

$${N}_{SC}^{e , j , rs}$$

interlace groups (e.g., sequentially denoted as

$${ig}_{0}^{e , j} , {ig}_{1}^{e , j} , … , and {ig}_{{N}_{SC}^{e , j , rs} - 1}^{e , j}$$

in ascending order according to the interlace with the smallest index in each interlace group). For example, for

$${μ}_{b , 0} = 0 , {N}_{INT}^{e , j} = {M}_{INT} = 10 , and {N}_{SC}^{e , j , rs} = 5 ,$$

the number (e.g., denoted as

$${N}_{INT , SC}^{e , j} )$$

of interlaces in each interlace group may be equal to 10/5=2. Correspondingly,

$${ig}_{0}^{e , j}$$

may correspond to a set {int₀, int₁},

$${ig}_{1}^{e , j}$$

may correspond to a set {int₂, int₃}, . . . , and

$${ig}_{4}^{e , j}$$

may correspond to a set {int₈, int₉}. For

$$i ∈ \{ 0 , 1 , … , {N}_{RS}^{e , j} - 1 \} ,$$

each subchannel in the RB set

$${rs}_{i}^{e , j}$$

may correspond to one interlace group. For example, a subchannel

$$( e . g . , denoted as {sc}_{{k}_{i}}^{e , j , rs , i} )$$

with an index being

$${k}_{i} ( {k}_{i} ∈ [ 0 , {N}_{SC}^{e , j , rs} - 1 ] )$$

### in the RB set

$${rs}_{i}^{e , j}$$

may be mapped to an intersection of RBs in the RB set

$${rs}_{i}^{e , j}$$

and RBs in an interlace in the interlace group

$${ig}_{{k}_{i}}^{e , j}$$

(or described as the subchannel

$${sc}_{{k}_{i}}^{e , j , rs , i}$$

may be mapped to all RBs that belong to the RB set

$${rs}_{i}^{e , j}$$

and that belong to any interlace in the interlace group

$${ig}_{{k}_{i}}^{e , j} ” ) ,$$

wherein

$${N}_{INT , SC}^{e , j}$$

interlaces included in each interlace group may be

$${N}_{INT , SC}^{e , j}$$

contiguous interlaces.

$${N}_{INT , SC}^{e , j}$$

may be an integer greater than or equal to 1.

$${N}_{INT , SC}^{e , j}$$

may be a value of one pre-defined or (pre-)configured parameter. For example, the

$${N}_{INT , SC}^{e , j}$$

may be (pre-)configured by using a parameter sl-NumInterlacesPerSubchannel).

$${N}_{INT , SC}^{e , j}$$

may be determined based on a value of one or more pre-defined or (pre-)configure parameters.

$${N}_{INT , SC}^{e , j}$$

may be determined based on

$${N}_{INT}^{e , j} and {N}_{SC}^{e , j , rs} , e . g . , {N}_{INT , SC}^{e , j} = {N}_{INT}^{e , j} / {N}_{SC}^{e , j , rs} .$$

$${N}_{SC}^{e , j , rs}$$

may be an integer greater than or equal to 1.

$${N}_{SC}^{e , j , rs}$$

may be a value of one pre-defined or (pre-)configured parameter. For example, the

$${N}_{SC}^{e , j , rs}$$

may be (pre-)configured by using a parameter sl-NumSubchannelsPerRBSet).

$${N}_{SC}^{e , j , rs}$$

may be determined based on a value of one or more pre-defined or (pre-)configured parameters.

$${N}_{SC}^{e , j , rs}$$

may be determined based on

$${N}_{INT}^{e , j} and {N}_{INT , SC}^{e , j} , e . g . , {N}_{SC}^{e , j , rs} = {N}_{INT}^{e , j} / {N}_{INT , SC}^{e , j} .$$

For

$${k}_{i} ∈ [ 0 , {N}_{SC}^{e , j , rs} - 1 ] ,$$

the index kᵢ corresponding to the subchannel

$${sc}_{{k}_{i}}^{e , j , rs , i}$$

may be referred to as a “type 2A subchannel index”, or be referred to as a “subchannel index in the RB set

$${rs}_{i}^{e , j} ” .$$

For example, if the resource pool eⱼ includes

$${N}_{RS}^{e , j} = 2$$

RB sets (e.g., RB sets

$${rs}_{0}^{e , j} and {rs}_{1}^{e , j} ) , and {N}_{SC}^{e , j , rs} = 3 ,$$

then the RB set

$${rs}_{0}^{e , j}$$

includes three subchannels with type 2A subchannel indexes (e.g., in ascending order of starting PRBs of the subchannels) being 0, 1, and 2, respectively, and the RB set

$${rs}_{1}^{e , j}$$

includes three subchannels with type 2A subchannel indexes (e.g., in ascending order of starting PRBs of the subchannels) being 0, 1, and 2, respectively.

In the subchannel mapping scheme 2, the set SC_{e,j} of subchannels in the resource pool eⱼ may be a union of a set

$${SC}_{rs , 0}^{e , j} ,$$

a set

$${SC}_{rs , 1}^{e , j} , … ,$$

and a set

$${SC}_{rs , {N}_{RS}^{e , j} - 1}^{e , j} ,$$

wherein for i∈

$$\{ 0 , 1 , … , {N}_{RS}^{e , j} - 1 \} , {SC}_{rs , i}^{e , j}$$

may be defined as

$$\{ {sc}_{0}^{e , j , rs , i} , {sc}_{1}^{e , j , rs , i} , … , {sc}_{{N}_{SC}^{e , j , rs} - 1}^{e , j , rs , i} \} .$$

In the subchannel mapping scheme 2, the number

$${N}_{SC}^{e , j}$$

of subchannels in the resource pool eⱼ may be equal to

$${N}_{RS}^{e , j} \cdot {N}_{SC}^{e , j , rs} .$$

In the subchannel mapping scheme 2, one subchannel index unique in the resource pool may be allocated to each subchannel in one resource pool. For example, one incrementing index starting from 0 (each such index may be referred to as a “type 2B subchannel index”) is sequentially allocated to each subchannel in one resource pool in a manner of incrementing an index of the RB set first and then incrementing a subchannel index in the RB set. In another example, one incrementing index starting from 0 (each such index may be referred to as a “type 2C subchannel index”) is sequentially allocated to each subchannel in one resource pool in a manner of incrementing a subchannel index in the RB set first and then incrementing an index of the RB set. In another example, one type 1 subchannel index is allocated to each subchannel in the resource pool.

Specifically, for example, the resource pool eⱼ includes

$${N}_{RS}^{e , j} = 2$$

RB sets

$$( e . g . , RB sets {rs}_{0}^{e , j} and {rs}_{1}^{e , j} ) ,$$

wherein each RB set corresponds to

$${N}_{SC}^{e , j , rs} = 3$$

subchannels.
The type 2A subchannel index 0 in the RB set

$${rs}_{0}^{e , j}$$

and the type 2B subchannel index corresponding to the type 2A subchannel index 0 in the RB set

$${rs}_{1}^{e , j}$$

are 0 and 1, respectively.
The type 2A subchannel index 1 in the RB set

$${rs}_{0}^{e , j}$$

and the type 2B subchannel index corresponding to the type 2A subchannel index 1 in the RB set

$${rs}_{1}^{e , j}$$

are 2 and 3, respectively.
The type 2A subchannel index 2 in the RB set

$${rs}_{0}^{e , j}$$

and the type 2B subchannel index corresponding to the type 2A subchannel index 2 in the RB set

$${rs}_{1}^{e , j}$$

are 4 and 5, respectively.
The type 2C subchannel indexes corresponding to the type 2A subchannel indexes 0, 1, and 2 in the RB set

$${rs}_{0}^{e , j}$$

are 0, 1, and 2, respectively.
The type 2C subchannel indexes corresponding to the type 2A subchannel indexes 0, 1, and 2 in the RB set

$${rs}_{1}^{e , j}$$

are 3, 4, and 5, respectively.
The type 1 subchannel indexes corresponding to the type 2A subchannel indexes 0, 1, and 2 in the RB set

$${rs}_{0}^{e , j}$$

are 0, 1, and 2, respectively.
The type 1 subchannel indexes corresponding to the type 2A subchannel indexes 0, 1, and 2 in the RB set

$${rs}_{1}^{e , j}$$

are 3, 4, and 5, respectively.

In the subchannel mapping scheme 2, for any subchannel in one resource pool, the “type 2C subchannel index” and the “type 1 subchannel index” may always be equal (in this sense, in the subchannel mapping scheme 2, the “type 2C subchannel index” and the “type 1 subchannel index” may be considered to be equivalent).

The subchannel mapping scheme 2 (or a non-contiguous RB-based PSSCH transmission; or an interlace RB-based PSSCH transmission; or a non-contiguous RB-based PSCCH/PSSCH transmission; or an interlace RB-based PSCCH/PSSCH transmission) may be applicable to (or applicable only to) an unlicensed spectrum.

For the unlicensed spectrum, the subchannel mapping scheme 2 (or a non-contiguous RB-based PSSCH transmission; or an interlace RB-based PSSCH transmission; or a non-contiguous RB-based PSCCH/PSSCH transmission; or an interlace RB-based PSCCH/PSSCH transmission) may be applicable to (or applicable only to) some subcarrier spacing configurations (e.g., a subcarrier spacing configuration 0; in another example, a subcarrier spacing configuration 1).

The subchannel mapping scheme 2 (or a non-contiguous RB-based PSSCH transmission; or an interlace RB-based PSSCH transmission; or a non-contiguous RB-based PSCCH/PSSCH transmission; or an interlace RB-based PSCCH/PSSCH transmission) may be applicable to (or applicable only to) an operation with shared spectrum channel access.

For the operation with shared spectrum channel access, the subchannel mapping scheme 2 (or a non-contiguous RB-based PSSCH transmission; or an interlace RB-based PSSCH transmission; or a non-contiguous RB-based PSCCH/PSSCH transmission; or an interlace RB-based PSCCH/PSSCH transmission) may be applicable to (or applicable only to) some subcarrier spacing configurations (e.g., a subcarrier spacing configuration 0; in another example, a subcarrier spacing configuration 1).

One resource pool (e.g., the resource pool eⱼ) may be pre-defined or (pre-)configured to use one (e.g., the subchannel mapping scheme 1; in another example, the subchannel mapping scheme 2) of a plurality of pre-defined or (pre-)configured subchannel mapping schemes.

In the subchannel mapping scheme 2, one or more “intra-RB-set subchannel allocation schemes” (e.g., referred to as an “intra-RB-set subchannel allocation scheme 2A”, an “intra-RB-set subchannel allocation scheme 2B”, and an “intra-RB-set subchannel allocation scheme 2C”, respectively) may be defined, wherein each such intra-RB-set subchannel allocation scheme may be used to determine one set of subchannels in one RB set, and each element in the set of subchannels may be represented by one type 2A subchannel index. For example, one subset of the set

$${SC}_{rs , i}^{e , j}$$

of subchannels in the RB set

$${rs}_{i}^{e , j} ( i ∈ \{ 0 , 1 , … , {N}_{RS}^{e , j} - 1 \} )$$

in the resource pool eⱼ may be determined according to one intra-RB-set subchannel allocation scheme. It may be considered that one intra-RB-set subchannel allocation scheme defines one or more “patterns” of one set of subchannels determined in one RB set.

For example, in the intra-RB-set subchannel allocation scheme 2A, the allocated set of subchannels is a set consisting of one or more contiguous subchannels in one RB set. For example, in the resource pool eⱼ, one set

$${SC}_{IN , RS}^{e , j} = \{ {sc}_{0}^{e , j , IN , RS} + l \vert l = 0 , 1 , … , {N}_{IN , RS}^{e , j} - 1 \}$$

of subchannels may be allocated in the RB set

$${rs}_{i}^{e , j} ( i ∈ \{ 0 , 1 , … , {N}_{RS}^{e , j} - 1 \} ) ,$$

wherein

$${N}_{IN , RS}^{e , j}$$

may be an integer greater than or equal to 1.

In another example, in the intra-RB-set subchannel allocation scheme 2B, the allocated set of subchannels is one pre-defined or (pre-)configured set of subchannels in one RB set. For example, in the resource pool eⱼ, one set

$${SC}_{IN , RS}^{e , j} = \{ {sc}_{0}^{e , j , IN , RS} + l \vert l ∈ {L}_{IN , RS}^{e , j} \}$$

of subchannels may be allocated in the RB set

$${rs}_{i}^{e , j} ( i ∈ \{ 0 , 1 , … , {N}_{RS}^{e , j} - 1 \} ) ,$$

wherein

$${sc}_{0}^{e , j , IN , RS}$$

may represent one starting subchannel, and

$${L}_{IN , RS}^{e , j}$$

may represent one set that includes one or more subchannel offsets. Each element in the set

$${SC}_{IN , RS}^{e , j}$$

may be determined based on one pre-defined or (pre-)configured combination of

$${sc}_{0}^{e , j , IN , RS} and {L}_{IN , RS}^{e , j} .$$

For example, the set

$${SC}_{IN , RS}^{e , j}$$

may correspond to a combination of

$${sc}_{0}^{e , j , IN , RS} and {L}_{IN , RS}^{e , j} ,$$

which is determined separately by some or all rows in the table below:

| Combination index | ${sc}_{0}^{e , j , IN , RS}$ | ${L}_{IN , RS}^{e , j}$ |
|---|---|---|
| 0 | 0 | {0, 5} |
| 1 | 0 | (0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

In another example, in the intra-RB-set subchannel allocation scheme 2C, the allocated set of subchannels is a set consisting of one or more contiguous or non-contiguous subchannels in one RB For example, in the resource pool eⱼ, one set

$${SC}_{IN , RS}^{e , j}$$

of subchannels may be allocated in the RB set

$${rs}_{i}^{e , j} ( i ∈ \{ 0 , 1 , … , {N}_{RS}^{e , j} - 1 \} ) ,$$

wherein the set

$${SC}_{IN , RS}^{e , j}$$

may be any non-empty subset of the set

$${SC}_{rs , i}^{e , j}$$

consisting of all subchannels in the RB set

$${rs}_{i}^{e , j} .$$

The intra-RB-set subchannel allocation scheme used in one resource pool may be related to a (pre-)configured subcarrier spacing configuration thereof. For example, for the resource pool eⱼ, if μ_{b,0}=0, then the intra-RB-set subchannel allocation scheme 2A and/or the intra-RB-set subchannel allocation scheme 2B may be used. In another example, for the resource pool eⱼ, if μ_{b,0}=1, then the intra-RB-set subchannel allocation scheme 2C may be used.

In the subchannel mapping scheme 2, one or more “RB set allocation schemes” (e.g., referred to as an “RB set allocation scheme 2A”, an “RB set allocation scheme 2B”, and an “RB set allocation scheme 2C”, respectively) may be defined, wherein each such RB set allocation scheme may be used to determine one set of RB sets in one resource pool, for example, one subset of the set RS_{e,j} of RB sets in the resource pool eⱼ may be determined according to one RB set allocation scheme.

For example, in the RB set allocation scheme 2A, the allocated set of RB sets is a set consisting of one or more contiguous RB sets in one resource pool (e.g., a set

$$\{ {rs}_{0}^{e , j} , {rs}_{1}^{e , j} \}$$

consisting of two contiguous RB sets in the resource pool eⱼ).

In another example, in the RB set allocation scheme 2B, the allocated set of RB sets is one pre-defined or (pre-)configured set of RB sets in one resource pool.

In another example, in the RB set allocation scheme 2C, the allocated set of RB sets is a set consisting of one or more contiguous or non-contiguous RB sets in one resource pool. For example, for the resource pool eⱼ, any non-empty subset of the set RS_{e,j} of RB sets may be allocated.

In the subchannel mapping scheme 2, one or more RB sets may be determined according to one RB set allocation scheme, and one set of subchannels may be determined based on one intra-RB-set subchannel allocation scheme. Correspondingly, one sidelink resource may correspond to a union of the sets of subchannels in the one or more RB sets. For example, one sidelink resource may correspond to subchannels 0 and 1 in the RB set

$${rs}_{0}^{e , j} ,$$

subchannels 0 and 1 in the RB set

$${rs}_{1}^{e , j} ,$$

and subchannels 0 and 1 in the RB

$${rs}_{2}^{e , j} ,$$

wherein the RB sets

$${rs}_{0}^{e , j} ,$$

$${rs}_{1}^{e , j} , and {rs}_{2}^{e , j}$$

may be determined according to the RB set allocation scheme A, and the subchannels 0 and 1 may be determined according to the intra-RB-set subchannel allocation scheme 2A.

### Embodiment 1

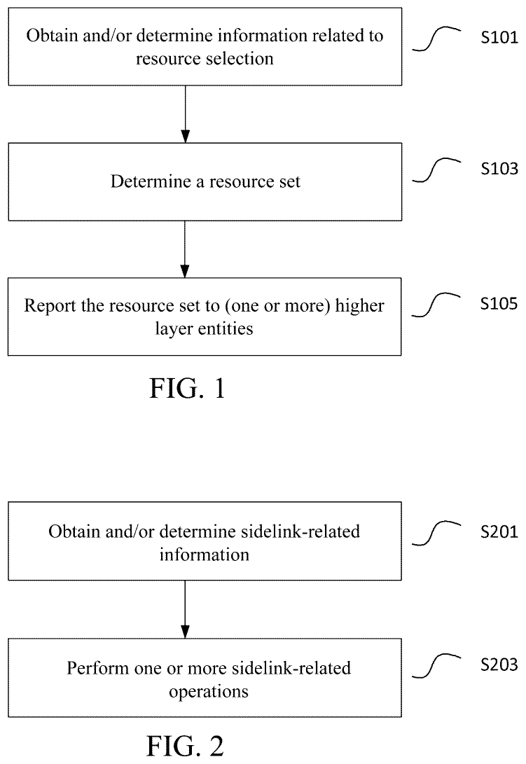

A method performed by a UE according to Embodiment 1 of the present invention will be described below with reference to FIG. 1.

Embodiment 1 of the present invention may correspond to some or all steps of a type 1 sidelink transmission resource determining procedure, wherein the type 1 sidelink transmission resource determining procedure may be used to determine a resource subset for PSSCH resource selection in a higher layer.

The type 1 sidelink transmission resource determining procedure may be triggered by (one or more) higher layer entities in a slot n, wherein the (one or more) higher layer entities may be higher layer entities of the UE.

FIG. 1 illustrates a flowchart corresponding to the method performed by a UE according to Embodiment 1 of the present invention.

As illustrated in FIG. 1, in Embodiment 1 of the present invention, the steps performed by the UE include: step S101, step S103, and step S105.

Specifically, in step S101, information related to resource selection (e.g., denoted as

$${Inf}_{0}^{ReSe} )$$

is obtained and/or determined.

$${Inf}_{0}^{ReSe}$$

may include one or more of scheduling information, (pre-)configuration information, control information, and indication information.

$${Inf}_{0}^{ReSe}$$

may include pre-defined information and/or (pre-)configured information.

$${Inf}_{0}^{ReSe}$$

may include information that is received by the UE and that is transmitted by another node (e.g., a base station, or another UE).

$${Inf}_{0}^{ReSe}$$

may include information indicated by the (one or more) higher layer entities, e.g., one or more parameters provided by the (one or more) higher layer entities when triggering the type 1 sidelink transmission resource determining procedure.

Part or all of

$${Inf}_{0}^{ReSe}$$

may be included in a system information block (SIB, e.g., SIB12).

Part or all of

$${Inf}_{0}^{ReSe}$$

may be included in one sidelink RRC reconfiguration message.

Part or all of

$${Inf}_{0}^{ReSe}$$

may be related to one resource pool (e.g., the resource pool eⱼ) in one bandwidth part (e.g., the bandwidth part b₀) in one carrier (e.g., the carrier c₀), wherein information (e.g., the index of the resource pool eⱼ; in another example, a subchannel mapping scheme and/or other (pre-)configuration information used for the resource pool eⱼ (or the bandwidth part b₀ or the carrier c₀); in another example, the subcarrier spacing configuration μ_{b,0} of the bandwidth part b₀) of any one of the carrier c₀, the bandwidth part b₀, and the resource pool eⱼ may be determined in a pre-defined or configured manner, or may be included in

$${Inf}_{0}^{ReSe}$$

(e.g., provided by the (one or more) higher layer entities when triggering the type 1 sidelink transmission resource determining procedure).

$${Inf}_{0}^{ReSe}$$

may include one parameter (e.g., denoted as L_{subCH}) indicating “the number of subchannels”. L_{subCH} may represent the number of subchannels for one sidelink transmission (e.g., one PSCCH/PSSCH transmission; in another example, one PSSCH transmission), or may represent the number of subchannels for each sidelink transmission in a plurality of sidelink transmissions (e.g., a plurality of PSCCH/PSSCH transmissions; in another example, a plurality of PSSCH transmissions).

$${Inf}_{0}^{ReSe}$$

may include an indication of a resource selection mechanism (e.g., denoted as rsm₀). For example, rsm₀ is “full sensing”. In another example, rsm₀ is “partial sensing”.

In addition, in step S103, a resource set (e.g., denoted as S_{A}) is determined.

For example, the set S_{A} is determined according to the resource selection mechanism rsmₐ, wherein the resource selection mechanism rsmₐ be rsm₀, or may be a default resource selection mechanism (e.g., when

$${Inf}_{0}^{ReSe}$$

does not include the indication of rsm₀), and the default resource selection mechanism may be “full sensing”.

The set S_{A} may be a subset of the set

$${S}_{all}^{Cand}$$

(in this sense, the set S_{A} may also be referred to as a “resource subset”). For example, the set S_{A} may be initialized into the set

$${S}_{all}^{Cand} ,$$

and then zero, one or more of the following operations and/or other operations are performed on the set S_{A} based on the resource selection mechanism rsmₐ, to obtain the final set S_{A}:
One or more “resource exclusion” operations, wherein each “resource exclusion” operation may be performed to exclude (or referred to as “remove”) zero, one or more elements from the set S_{A}.
One or more operations of re-initializing the set S_{A} into the set

$${S}_{all}^{Cand} .$$

For example, when one “resource exclusion” operation causes the number of elements in the set S_{A} to be less than a pre-defined or (pre-)configured or otherwise determined threshold, one of the re-initialization operations is performed.
One or more operations that are performed on the set S_{A} and that are determined independently by the UE.

The set

$${S}_{all}^{Cand}$$

may be a set consisting of all type 1 sidelink candidate resources, wherein one type 1 sidelink candidate resource may be defined as any set (e.g., denoted as

$${SC}_{css}^{e , j} = \{ {sc}_{0}^{e , j , css} , {sc}_{1}^{e , j , css} , … , {sc}_{{N}_{css}^{e , j} - 1}^{e , j , css} \} ,$$

wherein

$${N}_{css}^{e , j}$$

may be an integer greater than or equal to 1) of subchannels that satisfies a type 1 sidelink candidate frequency domain condition in any slot (e.g., denoted as

$${t}_{i}^{e , j} )$$

that satisfies a type 1 sidelink candidate time domain condition in the resource pool eⱼ.

An order of elements in the set

$${SC}_{css}^{e , j}$$

of subchannels may be an ascending order of starting PRBs of all respective subchannels, or may be an ascending order of indexes (e.g., for the subchannel mapping scheme 1, the “index” here may be a type 1 subchannel index; in another example, for the subchannel mapping scheme 2, the “index” here may be a type 2B subchannel index; in another example, for the subchannel mapping scheme 2, the “index” here may be a type 2C subchannel index) of all respective subchannels.

The type 1 sidelink candidate time domain condition may be that the slot

$${t}_{i}^{e , j}$$

is one slot in the set

$${T}_{CSS}^{e , j , n}$$

of slots.

The set

$${T}_{CSS}^{e , j , n}$$

of slots may be related to the resource selection mechanism rsmₐ. For example, if the resource selection mechanism rsmₐ is “full sensing”, then

$${T}_{CSS}^{e , j , n} = {T}_{W}^{e , j , n} ,$$

wherein

$${T}_{W}^{e , j , n}$$

is a set consisting of all slots belonging to the resource pool eⱼ in a first resource selection window (e.g., denoted as Wₙ). In another example, if the resource selection mechanism rsmₐ is “partial sensing”, then

$${T}_{CSS}^{e , j , n}$$

is a set consisting of Y_{PS} slots in the set

$${T}_{W}^{e , j , n}$$

of slots, wherein the Y_{PS} slots may be referred to as Y_{PS} “candidate slots”. A value of Y_{PS} may be related to factors such as whether the “partial sensing” operation includes periodic-based partial sensing, and whether the corresponding resource selection is triggered based on periodic transmission or aperiodic transmission. The Y_{PS} slots may be determined independently by the UE or otherwise determined.

The first resource selection window Wₙ may be defined as a time gap [n+T₁, n+T₂], wherein T₁ may be a slot offset determined independently by the UE. T₁ may be a value satisfying

$$0 \leq {T}_{1} \leq {T}_{proc , 1}^{SL} ,$$

wherein

$${T}_{proc , 1}^{SL}$$

may be a pre-defined or (pre-)configured value that is related to a respective subcarrier spacing configuration (e.g., λ_{b,0}). T₂ may be related to a remaining packet delay budget (e.g., denoted as T_{RPD}). For example, if there is one T₂ₘᵢₙ such that T₂ₘᵢₙ≤T_{RPD}, then T₂ may be a value in a range [T₂ₘᵢₙ, T_{RPD}] determined independently by the UE. In another example, if there is no T₂ₘᵢₙ, then T₂=T_{RPD}.

The type 1 sidelink candidate frequency domain condition may be related to one or more factors including one or more of the following:
A characteristic of a spectrum in which the carrier c₀ is located (e.g., whether the spectrum is a licensed spectrum or an unlicensed spectrum) and/or a type of a corresponding operation (e.g., whether the corresponding operation is an operation with shared spectrum channel access or an operation without shared spectrum channel access).
A subchannel mapping scheme used for the resource pool eⱼ (or the bandwidth part b₀, or the carrier c₀).
λ_{b,0}.

For example, if the resource pool eⱼ (or the bandwidth part b₀ or the carrier c₀) uses the subchannel mapping scheme 1, then the type 1 sidelink candidate frequency domain condition may include one or more of the following (e.g., any of the combinations made by way of “and” or “or”):
Type 1A sidelink candidate frequency domain condition.
Type 1B sidelink candidate frequency domain condition.

In another example, if the resource pool eⱼ (or the bandwidth part b₀ or the carrier c₀) uses the subchannel mapping scheme 2, then the type 1 sidelink candidate frequency domain condition may include one or more of the following (e.g., any of the combinations made by way of “and” or “or”):
Type 1C sidelink candidate frequency domain condition.
Type 1D sidelink candidate frequency domain condition.
Type 1E sidelink candidate frequency domain condition.
Type 1F sidelink candidate frequency domain condition.

The type 1A sidelink candidate frequency domain condition may include one or more of the following (e.g., any of the combinations made by way of “and” or “or”):

$${N}_{css}^{e , j} = {L}_{subCH} .$$

$${N}_{css}^{e , j} \geq {L}_{subCH} .$$

The

$${N}_{css}^{e , j}$$

subchannels in the set

$${SC}_{css}^{e , j} are {N}_{css}^{e , j}$$

are Ness contiguous subchannels in the resource pool eⱼ.

For example, if L_{subCH}=3, the number of subchannels in the resource pool eⱼ is

$${N}_{SC}^{e , j} = 5 ,$$

and the type 1A sidelink candidate frequency domain condition is defined as

$$“ {N}_{css}^{e , j} = {L}_{subCH} ,$$

and the

$${N}_{css}^{e , j}$$

subchannels are

$${N}_{css}^{e , j}$$

contiguous subchannels in the resource pool eⱼ”, then the set of subchannels satisfying the type 1A sidelink candidate frequency domain condition may be {0, 1, 2}, {1, 2, 3}, and {2, 3, 4}.

The type 1B sidelink candidate frequency domain condition may include one or more of the following (e.g., any of the combinations made by way of “and” or “or”):
The lowest subchannel (i.e., the subchannel

$${sc}_{0}^{e , j , css} )$$

in the set

$${SC}_{css}^{e , j}$$

does not include any “guard band RB”.

$${N}_{PC , RB}^{e , j}$$

RBs with the lowest index (e.g., the PRB index) included in the lowest subchannel (i.e., the subchannel

$${sc}_{0}^{e , j , css} )$$

in the set

$${SC}_{css}^{e , j}$$

do not include any “guard band RB”, wherein the

$${N}_{PC , RB}^{e , j}$$

may be the number of RBs used for PSCCH that are pre-defined or (pre-)configured (e.g., (pre-)configured by using the parameter sl-FreqResourcePSCCH) for the resource pool eⱼ. For example, if the set of PRBs corresponding to the subchannel

$${sc}_{0}^{e , j , css}$$

is {50, 51, . . . , 69}, and

$${N}_{PC , RB}^{e , j} = 10 ,$$

then

$${N}_{PC , RB}^{e , j}$$

RBs (represented by the PRB index) with the minimum index included in the subchannel

$${sc}_{0}^{e , j , css}$$

are 50, 51, . . . , and 59.

The type 1B sidelink candidate frequency domain condition is applicable to an unlicensed spectrum.

For the unlicensed spectrum, the type 1B sidelink candidate frequency domain condition is applicable to (or applicable only to) some subcarrier spacing configurations (e.g., a subcarrier spacing configuration 2 and a subcarrier spacing configuration 3; in another example, other subcarrier spacing configurations except for the subcarrier spacing configuration 0 and the subcarrier spacing configuration 1).

The type 1B sidelink candidate frequency domain condition is applicable to (or applicable only to) an operation with shared spectrum channel access.

For the operation with shared spectrum channel access, the type 1B sidelink candidate frequency domain condition is applicable to (or applicable only to) some subcarrier spacing configurations (e.g., a subcarrier spacing configuration 2 and a subcarrier spacing configuration 3; in another example, other subcarrier spacing configurations except for the subcarrier spacing configuration 0 and the subcarrier spacing configuration 1).

The type 1C sidelink candidate frequency domain condition may include one or more of the following (e.g., any of the combinations made by way of “and” or “or”):

$${N}_{c s s}^{e , j} = {L}_{subCH} .$$

$${N}_{c s s}^{e , j} \geq {L}_{subCH} .$$

The type 1D sidelink candidate frequency domain condition may include one or more of the following (e.g., any of the combinations made by way of “and” or “or”):
The

$${N}_{css}^{e , j}$$

subchannels in the set

$${SC}_{css}^{e , j}$$

consist of

$${N}_{css , {i}_{0}}^{e , j , SC}$$

subchannels in the RB set

$$r {s}_{{i}_{0}}^{e , j}$$

(e.g., the corresponding set of subchannels is denoted as

$${SC}_{css , {i}_{0}}^{e , j , SC} ) , {N}_{css , {i}_{1}}^{e , j , SC}$$

subchannels in the RB set

$$r {s}_{{i}_{1}}^{e , j}$$

(e.g., the corresponding set of subchannels is denoted as

$${SC}_{css , {i}_{1}}^{e , j , SC} ) , … , and {N}_{css , {i}_{{N}_{css}^{e , j , RS} - 1}}^{e , j , SC}$$

subchannels in the RB set

$${rs}_{{i}_{{N}_{css}^{e , j , RS} - 1}}^{e , j}$$

(e.g., the corresponding set of subchannels is denoted as

$${SC}_{css , {i}_{{N}_{css}^{e , j , RS} - 1}}^{e , j , SC} ) ,$$

wherein

$${N}_{c s s}^{e , j , RS}$$

may correspond to one parameter indicating “the number of RB sets”.

$${N}_{c s s}^{e , j , RS}$$

may be a value of one pre-defined or (pre-)configured parameter.

$${N}_{c s s}^{e , j , RS}$$

may be determined based on a value of one or more pre-defined or (pre-)configured parameters.

$${N}_{c s s}^{e , j , RS}$$

may be an integer less than or equal to

$${N}_{css , max}^{e , j , RS} ,$$

wherein

$${N}_{css , max}^{e , j , RS}$$

may be a value of one pre-defined or (pre-)configured parameter, or may be determined based on a value of one or more pre-defined or (pre-)configured parameters, e.g.,

$${N}_{css , max}^{e , j , RS} = {N}_{RS}^{e , j} .$$

$${N}_{c s s}^{e , j , RS}$$

may be an integer greater than or equal to

$${N}_{css , min}^{e , j , RS} ,$$

wherein

$${N}_{css , min}^{e , j , RS}$$

may be a value of one pre-defined or (pre-)configured parameter, or may be determined based on a value of one or more pre-defined or (pre-)configured parameters, e.g.,

$${N}_{css , min}^{e , j , RS} = 1.$$

$${N}_{css}^{e , j , RS}$$

may be an integer satisfying

$${N}_{css , min}^{e , j , RS} \leq {N}_{css}^{e , j , RS} \leq {N}_{css , max}^{e , j , RS} .$$

$${N}_{css}^{e , j , RS}$$

may be included in

$${Inf}_{0}^{R e S e} .$$

For example,

$${N}_{css , min}^{e , j , RS}$$

may be provided by the (one or more) higher layer entities when triggering the type 1 sidelink transmission resource determining procedure.
For

$$k ∈ [ 0 , {N}_{c s s}^{e , j , RS} - 1 ] ,$$

iₖ may be an element in the set

$$\{ 0 , 1 , … , {N}_{R S}^{e , j} - 1 \} .$$

The set consisting of the RB set

$$r {s}_{{i}_{0}}^{e , j} ,$$

### the RB set

$$r {s}_{{i}_{1}}^{e , j} ,$$

### . . . , and the RB set

$${rs}_{{i}_{{N}_{css}^{e , j , RS} - 1}}^{e , j}$$

may be denoted as

$$R {S}_{c s s}^{e , j , RS} = \{ r {s}_{{i}_{0}}^{e , j} , r {s}_{{i}_{1}}^{e , j} , … , {rs}_{{i}_{{N}_{css}^{e , j , RS} - 1}}^{e , j} \} .$$

Each of

$${N}_{css , {i}_{0}}^{e , j , SC} , {N}_{css , {i}_{1}}^{e , j , SC} , … , and {N}_{css , {i}_{{N}_{css}^{e , j , RS} - 1}}^{e , j , SC}$$

may be an integer greater than or equal to 1.

$${N}_{css}^{e , j}$$

may be equal to

$${N}_{css , {i}_{0}}^{e , j , SC} + {N}_{css , {i}_{1}}^{e , j , SC} + … + {N}_{css , {i}_{{N}_{css}^{e , j , RS} - 1}}^{e , j , SC} .$$

$${N}_{css}^{e , j , RS}$$

RB sets in the set

$$R {S}_{c s s}^{e , j , RS}$$

may be

$${N}_{c s s}^{e , j , RS}$$

contiguous RB sets. For example, for

$$k ∈ [ 0 , {N}_{c s s}^{e , j , RS} - 2 ] , {i}_{k + 1} = {i}_{k} + 1.$$

$${N}_{css , {i}_{0}}^{e , j , SC} = {N}_{css , {i}_{1}}^{e , j , SC} = … = {N}_{css , {i}_{{N}_{css}^{e , j , RS} - 1}}^{e , j , SC} ,$$

for example, may be denoted as

$${N}_{css , {i}_{0}}^{e , j , SC} = {N}_{css , {i}_{1}}^{e , j , SC} = … = {N}_{css , {i}_{{N}_{css}^{e , j , RS} - 1}}^{e , j , SC} = {N}_{css , RS}^{e , j , SC} .$$

### Correspondingly,

$${N}_{css}^{e , j}$$

may be equal to

$${N}_{css}^{e , j , RS} \cdot {N}_{css , RS}^{e , j , SC} ,$$

wherein

$${N}_{css , RS}^{e , j , SC}$$

N may correspond to one parameter indicating “the number of subchannels in the RB set”.

$${N}_{css , RS}^{e , j , SC}$$

may be a value of one pre-defined or (pre-)configured parameter.

$${N}_{css , RS}^{e , j , SC}$$

may be determined based on a value of one or more pre-defined or (pre-)configured parameters.

$${N}_{css , RS}^{e , j , SC}$$

may be an integer less than or equal to

$${N}_{css , RS , max}^{e , j , SC} ,$$

wherein

$${N}_{css , RS , max}^{e , j , SC}$$

may be a value of one pre-defined or (pre-)configured parameter, or may be determined based on a value of one or more pre-defined or (pre-)configured parameters, e.g.,

$${N}_{css , RS , max}^{e , j , SC} = {N}_{SC}^{e , j , rs} .$$

$${N}_{css , RS}^{e , j , SC}$$

may be an integer greater than or equal to

$${N}_{css , RS , min}^{e , j , SC} ,$$

wherein

$${N}_{css , RS , min}^{e , j , SC}$$

may be a value of one pre-defined or (pre-)configured parameter, or may be determined based on a value of one or more pre-defined or (pre-)configured parameters, e.g.,

$${N}_{css , RS , min}^{e , j , SC} = 1.$$

$${N}_{css , RS}^{e , j , SC}$$

may be an integer satisfying

$${N}_{css , RS , min}^{e , j , SC} \leq {N}_{css , RS}^{e , j , SC} \leq {N}_{css , RS , max}^{e , j , SC} .$$

$${N}_{css , RS}^{e , j , SC}$$

may be included in

$${Inf}_{0}^{R e S e} .$$

For example,

$${N}_{css , RS}^{e , j , SC}$$

may be provided by the (one or more) higher layer entities when triggering the type 1 sidelink transmission resource determining procedure.

$${N}_{css , RS}^{e , j , SC}$$

may be determined based on

$${N}_{c s s}^{e , j} and {N}_{c s s}^{e , j , RS} , e . g . , {N}_{c s s , R S}^{e , j , SC} = {N}_{c s s}^{e , j} / {N}_{c s s}^{e , j , RS} .$$

$${N}_{css}^{e , j , RS}$$

may be determined based on

$${N}_{c s s}^{e , j} and {N}_{css , RS}^{e , j , SC} , e . g . , {N}_{css}^{e , j , RS} = {N}_{c s s}^{e , j} / {N}_{css , RS}^{e , j , SC} .$$

$${SC}_{css , {i}_{0}}^{e , j , SC} = {SC}_{css , {i}_{1}}^{e , j , SC} = … = {SC}_{css , {i}_{{N}_{css}^{e , j , RS} - 1}}^{e , j , SC} ,$$

for example, may be denoted as

$${SC}_{css , {i}_{0}}^{e , j , SC} = {SC}_{css , {i}_{1}}^{e , j , SC} = … = {SC}_{css , {i}_{{N}_{css}^{e , j , RS} - 1}}^{e , j , SC} = {SC}_{css}^{e , j , SC} .$$

Specifically, for example, if

$${RS}_{css}^{e , j , RS} = \{ {rs}_{0}^{e , j} , {rs}_{1}^{e , j} , {rs}_{2}^{e , j} \} , and {SC}_{css}^{e , j , SC} = \{ 0 , 1 \}$$

(e.g., a type 2A subchannel index is used to represent a subchannel in the set

$${SC}_{css ,}^{e , j , SC} )$$

then

$${N}_{css}^{e , j} = 6 ,$$

and the

$${N}_{css}^{e , j}$$

subchannels consist of the subchannel 0 and the subchannel 1 in the RB set

$$r {s}_{0}^{e , j} ,$$

the subchannel 0 and the subchannel 1 in the RB set

$$r {s}_{1}^{e , j} ,$$

and the subchannel 0 and the subchannel 1 in the RB set

$$r {s}_{2}^{e , j}$$

in the resource pool eⱼ.

The type 1E sidelink candidate frequenc pmi n condition may include one or more of the following (e.g., any of the combinations made by way of “and” or “or”):
Each of the set

$${SC}_{css , {i}_{0}}^{e , j , SC} ,$$

the set

$${SC}_{css , {i}_{1}}^{e , j , SC} , … ,$$

and the set

$${SC}_{css , {i}_{{N}_{css}^{e , j , RS} - 1}}^{e , j , SC} ,$$

is a set of subchannels determined based on the intra-RB-set subchannel allocation scheme 2A.
For μ_{b,0}=0, each of the set

$${SC}_{css , {i}_{0}}^{e , j , SC} ,$$

the set

$${SC}_{css , {i}_{1}}^{e , j , SC} , … ,$$

and the set

$${SC}_{css , {i}_{{N}_{css}^{e , j , RS} - 1}}^{e , j , SC}$$

is a set of subchannels determined based on the intra-RB-set subchannel allocation scheme 2A.
Each of the set

$${SC}_{css , {i}_{0}}^{e , j , SC} ,$$

the set

$${SC}_{css , {i}_{1}}^{e , j , SC} , … ,$$

and the set

$${SC}_{css , {i}_{{N}_{css}^{e , j , RS} - 1}}^{e , j , SC}$$

is a set of subchannels determined based on the intra-RB-set subchannel allocation scheme 2B.
For μ_{b,0}=0, each of the set

$${SC}_{css , {i}_{0}}^{e , j , SC} ,$$

the set

$${SC}_{css , {i}_{1}}^{e , j , SC} , … ,$$

and the set

$${SC}_{css , {i}_{{N}_{css}^{e , j , RS} - 1}}^{e , j , SC}$$

is a set of subchannels determined based on the intra-RB-set subchannel allocation scheme 2B.
For μ_{b,0}=0, each of the set

$${SC}_{css , {i}_{0}}^{e , j , SC} ,$$

the set

$${SC}_{css , {i}_{1}}^{e , j , SC} , … ,$$

and the set

$${SC}_{css , {i}_{{N}_{css}^{e , j , RS} - 1}}^{e , j , SC}$$

is a set of subchannels determined based on the intra-RB-set subchannel allocation scheme 2A, or a set of subchannels determined based on the intra-RB-set subchannel allocation scheme 2B.
For μ_{b,0}=1, each of the set

$${SC}_{css , {i}_{0}}^{e , j , SC} ,$$

the set

$${SC}_{css , {i}_{1}}^{e , j , SC} , … ,$$

and the set

$${SC}_{css , {i}_{{N}_{c s s}^{e , j , RS} - 1}}^{e , j , SC}$$

is a set of subchannels determined based on the intra-RB-set subchannel allocation scheme 2C.

The type 1F sidelink candidate frequency domain condition may include one or more of the following (e.g., any of the combinations made by way of “and” or “or”):
The set

$$R {S}_{c s s}^{e , j , RS}$$

is a set of RB sets determined based on the RB set allocation scheme 2A.
The set

$$R {S}_{c s s}^{e , j , RS}$$

is a set of RB sets determined based on the RB set allocation scheme 2B.
The set

$$R {S}_{c s s}^{e , j , RS}$$

is a set of RB sets determined based on the RB set allocation scheme 2C.

Furthermore, in step S105, the resource set is reported to (one or more) higher layer entities.

The set S_{A} may be used for resource selection by the higher layer entity. For example, the higher layer entity may select one or more resources for sidelink transmission (e.g., PSCCH/PSSCH transmission; in another example, PSSCH transmission) from the set S_{A}.

Embodiment 1 of the present invention may be performed by a physical layer entity of the UE.

In Embodiment 1 of the present invention, the “subchannel mapping scheme 1” may be replaced with the “contiguous RB-based PSSCH transmission”.

In Embodiment 1 of the present invention, the “subchannel mapping scheme 1” may be replaced with the “non-interlace RB-based PSSCH transmission”.

In Embodiment 1 of the present invention, the “subchannel mapping scheme 1” may be replaced with the “contiguous RB-based PSCCH/PSSCH transmission”.

In Embodiment 1 of the present invention, the “subchannel mapping scheme 1” may be replaced with the “non-interlace RB-based PSCCH/PSSCH transmission”.

In Embodiment 1 of the present invention, the “subchannel mapping scheme 2” may be replaced with the “interlace RB-based PSSCH transmission”.

In Embodiment 1 of the present invention, the “subchannel mapping scheme 2” may be replaced with the “non-contiguous RB-based PSSCH transmission”.

In Embodiment 1 of the present invention, the “subchannel mapping scheme 2” may be replaced with the “interlace RB-based PSCCH/PSSCH transmission”.

In Embodiment 1 of the present invention, the “subchannel mapping scheme 2” may be replaced with the “non-contiguous RB-based PSCCH/PSSCH transmission”.

Embodiment 1 of the present invention is applicable to a resource allocation mode (e.g., a resource allocation mode 2 in an NR sidelink) in which a transmitting UE autonomously selects a resource for transmission.

Therefore, according to Embodiment 1, the present invention provides a method. When a resource subset for resource selection is determined for one PSSCH transmission in a resource pool configured with interlace-based PSSCH transmission, each candidate resource in a corresponding full set of candidate resources is defined as the same set of subchannels in each RB set of any number of contiguous RB sets in the resource pool, so that the full set of candidate resources as large as possible is obtained under the premise of satisfying a resource reservation signaling limitation, thereby increasing the flexibility of resource selection and reducing the probability of resource collision between different UEs.

### Embodiment 2

A method performed by a UE according to Embodiment 2 of the present invention will be described below with reference to FIG. 2.

FIG. 2 illustrates a flowchart corresponding to the method performed by a UE according to Embodiment 2 of the present invention.

As illustrated in FIG. 2, in Embodiment 2 of the present invention, the steps performed by the UE include: step S201 and step S203.

Specifically, in step S201, information related to a sidelink (e.g., denoted as

$${inf}_{0}^{SL} )$$

is obtained and/or determined.

$${inf}_{0}^{SL}$$

may include one or more of scheduling information, (pre-)configuration information, control information, and indication information.

Part or all of

$${inf}_{0}^{SL}$$

may be indicated in DCI (e.g., denoted as

$${DCI}_{0}^{SL} )$$

received by the UE.

$${DCI}_{0}^{S L}$$

may be carried by a physical downlink control channel (PDCCH), and the PDCCH may be transmitted by a base station to the UE.

$${DCI}_{0}^{SL}$$

may correspond to a DCI format for scheduling an NR sidelink (e.g., NR PSCCH and/or NR PSSCH), e.g., a DCI format 3_0.

Part or all of

$${inf}_{0}^{SL}$$

may be pre-defined or (pre-)configured or indicated in a higher layer protocol (e.g., a PC5-RRC layer; In another example, an RRC layer; in another example, a MAC layer), wherein the corresponding pre-definition or (pre-)configuration or indication information may be from one or more higher layer entities of the UE, and/or from the PC5-RRC signaling received by the UE and transmitted by another UE and/or the RRC signaling and/or MAC signaling transmitted by the base station to the UE.

$${DCI}_{0}^{S L}$$

may be used to schedule

$${N}_{sche}^{SL}$$

resources for sidelink transmission (e.g.,

$${N}_{sche}^{SL}$$

resources for PSSCH transmission; in another example

$${N}_{sche}^{SL}$$

resources for PSCCH/PSSCH transmission) in one resource pool (e.g., the resource pool eⱼ) in one bandwidth part (e.g., the bandwidth part b₀) in one carrier (e.g., the carrier c₀), which, for example, are denoted as

$${r}_{0}^{SL , sche} , {r}_{1}^{SL , sche} , … , and {r}_{{N}_{sche}^{SL} - 1}^{SL , sche} ,$$

respectively in chronological order. Information about any one of the carrier c₀, the bandwidth part b₀, and the resource pool eⱼ may be determined in a pre-defined or (pre-)configured manner, or be indicated in the

$${DCI}_{0}^{SL} .$$

For example, the resource pool eⱼ may be indicated by a “resource pool index” (or referred to as a “resource pool indicator”) field in the

$${DCI}_{0}^{SL} .$$

$${N}_{sche}^{SL}$$

may be an integer greater than or equal to

$$1 ( e . g . , {N}_{s c h e}^{SL} = 1 ; or {N}_{sche}^{SL} = 2 ; or {N}_{sche}^{SL} = 3 ) .$$

Each of the

$${N}_{s c h e}^{SL}$$

resources may correspond to the same number of subchannels (e.g., denoted as L_{subCH}).

A slot (e.g., denoted as

$${t}_{0}^{SL , sche} )$$

in which the resource

$${r}_{0}^{SL , sche}$$

is located may be indicated by a “time gap” field in

$${DCI}_{0}^{SL} .$$

For example, the slot

$${t}_{0}^{SL , sche}$$

may be calculated based on a downlink slot in which

$${DCI}_{0}^{SL}$$

is located and a slot offset provided (or indicted) by the “time gap” field.

$${DCI}_{0}^{SL}$$

may include a “lowest index of the subchannel allocation to the initial transmission” field. The “lowest index of the subchannel allocation to the initial transmission” field may be used to indicate an index of a subchannel with the lowest (or referred to as “minimum”) index among all subchannels corresponding to the resource

$${r}_{0}^{SL , sche} ,$$

wherein the definition of “index” here may be related to the subchannel mapping scheme used by the resource pool eⱼ. For example, the definition may be made based on one of the following:
Type 1 subchannel index. For example, this is applicable to the case that the resource pool eⱼ (or the bandwidth part b₀, or the carrier c₀) uses the subchannel mapping scheme 1. In another example, this is applicable to the case that the resource pool eⱼ (or the bandwidth part b₀, or the carrier c₀) uses the subchannel mapping scheme 2.
Type 2A subchannel index. For example, this is applicable to the case that the resource pool eⱼ (or the bandwidth part b₀, or the carrier c₀) uses the subchannel mapping scheme 2.
Type 2B subchannel index. For example, this is applicable to the case that the resource pool eⱼ (or the bandwidth part b₀, or the carrier c₀) uses the subchannel mapping scheme 2.
Type 2C subchannel index. For example, this is applicable to the case that the resource pool eⱼ (or the bandwidth part b₀, or the carrier c₀) uses the subchannel mapping scheme 2.

The size (e.g., denoted as

$${N}_{s i z e}^{LISC} ,$$

which represents

$${N}_{s i z e}^{LISC}$$

bits) of the “lowest index of the subchannel allocation to the initial transmission” field may be determined based on the number

$${N}_{SC}^{e , j}$$

of subchannels in the resource pool eⱼ. For example,

$${N}_{s i z e}^{LISC} = ⌈ {log}_{2} ( {N}_{SC}^{e , j} ) ⌉ .$$

$${N}_{s i z e}^{LISC}$$

may be related to the subchannel mapping scheme used for the resource pool eⱼ (or the bandwidth part b₀, or the carrier c₀). For example, if the resource pool eⱼ (or the bandwidth part b₀, or the carrier c₀) uses the subchannel mapping scheme 1, then

$${N}_{s i z e}^{LISC}$$

may be determined based on the number

$${N}_{SC}^{e , j}$$

of subchannels in the resource pool eⱼ. In another example, if the resource pool eⱼ (or the bandwidth part b₀, or the carrier c₀) uses the subchannel mapping scheme 2, then

$${N}_{s i z e}^{LISC}$$

may be determined based on the number

$${N}_{SC}^{e , j}$$

of subchannels in the resource pool eⱼ. In another example, if the resource pool eⱼ (or the bandwidth part b₀, or the carrier c₀) uses the subchannel mapping scheme 2, then

$${N}_{s i z e}^{LISC}$$

may be based on the number

$$( i . e . , {N}_{SC}^{e , j , rs} )$$

of subchannels,

$$e . g . , {N}_{s i z e}^{LISC} = ⌈ {log}_{2} ( {N}_{S C}^{e , j , rs} ) ⌉ ,$$

corresponding to each RB set in the resource pool eⱼ.

$${DCI}_{0}^{S L}$$

may include a “lowest index of the RB set allocation to the initial transmission” field. Optionally, if the resource pool eⱼ (or the bandwidth part b₀, or the carrier c₀) uses the subchannel mapping scheme 2, then

$${DCI}_{0}^{S L}$$

includes the “lowest index of the RB set allocation to the initial transmission” field. Optionally, if the resource pool eⱼ (or the bandwidth part b₀, or the carrier c₀) does not use the subchannel mapping scheme 2, then

$${DCI}_{0}^{S L}$$

does not include the “lowest index of the RB set allocation to the initial transmission” field. Optionally, if the resource pool eⱼ (or the bandwidth part b₀, or the carrier c₀) uses the subchannel mapping scheme 1, then

$${DCI}_{0}^{S L}$$

does not include the “lowest index of the RB set allocation to the initial transmission” field.

The “lowest index of the RB set allocation to the initial transmission” field may be used to indicate the lowest RB set index corresponding to the resource

$${r}_{0}^{SL , sche}$$

(e.g., the RB set index corresponding to the RB set with the lowest starting PRB in the resource pool eⱼ; in another example, the RB set index corresponding to the RB set with the lowest RB set index in the resource pool eⱼ). For example, if the resource

$${r}_{0}^{SL , sche}$$

corresponds to subchannels 0 and 1 in the RB set

$$r {s}_{0}^{e , j}$$

and subchannels 0 and 1 in the RB set

$$r {s}_{1}^{e , j}$$

in the resource pool eⱼ, then the RB set index indicated by the “lowest index of the RB set allocation to the initial transmission” field may be 0.

Part or all of frequency domain information of the

$${N}_{sche}^{SL}$$

resources (e.g., L_{subCH}; in another example, the lowest subchannel indexes respectively corresponding to the resource

$${r}_{1}^{SL , sche} , … ,$$

and the resource,

$${r}_{{N}_{sche}^{SL} - 1}^{SL , sche} )$$

may be indicated by means of a “frequency resource assignment” field in

$${DCI}_{0}^{SL} .$$

The “frequency resource assignment” field may be a field determined based on the definition of the corresponding (e.g., same-named) field in a first-stage SCI (e.g., SCI format 1-A). The “frequency resource assignment” indicated in

$${DCI}_{0}^{SL}$$

may be used to set the corresponding (e.g., same-named) field in the first-stage SCI in the sidelink transmission corresponding to the resource

$${r}_{0}^{SL , s c h e} .$$

Part or all of time domain information of the

$${N}_{s c h e}^{SL}$$

resources (e.g.,

$${N}_{s c h e}^{SL} ;$$

in another example, the slots in which the resource

$${r}_{1}^{SL , sche} , … ,$$

and the resource

$${r}_{{N}_{sche}^{SL} - 1}^{SL , sche}$$

are respectively located) may be indicated by a “time resource assignment” field in

$${DCI}_{0}^{SL} .$$

The “time resource assignment” field may be a field determined based on the definition of the corresponding (e.g., same-named) field in a first-stage SCI (e.g., SCI format 1-A). The “time resource assignment” indicated in

$${DCI}_{0}^{SL}$$

may be used to set the corresponding (e.g., same-named) field in the first-stage SCI in the sidelink transmission corresponding to the resource

$${r}_{0}^{SL , s c h e} .$$

Part or all of

$${inf}_{0}^{SL}$$

may be related to a sidelink grant (e.g., denoted as

$${grant}_{0}^{SL} ) .$$

For example, part or all of

$${inf}_{0}^{SL}$$

may correspond to part or all of parameters of

$${grant}_{0}^{SL}$$

and/or one or more operations related to

$${grant}_{0}^{SL} .$$

$${grant}_{0}^{SL}$$

may be a sidelink dynamic grant dynamically provided by

$${DCI}_{0}^{SL} .$$

For example, if the RNTI of the CRC used to scramble

$${DCI}_{0}^{SL}$$

is a sidelink RNTI (SL-RNTI), then

$${grant}_{0}^{SL}$$

corresponds to one sidelink dynamic grant. In another example, if the RNTI of the CRC used to scramble

$${DCI}_{0}^{SL}$$

is a sidelink configured scheduling RNTI (SLCS-RNTI, or referred to as “SL-CS-RNTI”), and a value of a “new data indicator (NDI)” field in

$${DCI}_{0}^{S L}$$

is 1, then

$${grant}_{0}^{SL}$$

corresponds to one sidelink dynamic grant.

$${grant}_{0}^{SL}$$

may be one of one or more type 2 sidelink configured grants (pre-)configured for the UE (e.g., (pre-)configured at the RRC layer). For example, if the RNTI of the CRC used to scramble

$${DCI}_{0}^{SL}$$

is an SLCS-RNTI, and the value of the NDI field

$${DCI}_{0}^{SL}$$

is 0, then

$${grant}_{0}^{SL}$$

corresponds to one type 2 sidelink configured grant. Correspondingly,
parameters (e.g., a period) of

$${grant}_{0}^{SL}$$

may be (pre-)configured at the RRC layer.

$${DCI}_{0}^{SL}$$

may be used to activate (or, deactivate; or release)

$${grant}_{0}^{SL} .$$

For example,
The “configuration index” corresponding to

$${grant}_{0}^{SL}$$

may be indicated in

$${DCI}_{0}^{SL} .$$

Further, in step S203, one or more sidelink-related operations are performed.

For example, according to the indication of

$${DCI}_{0}^{SL} ,$$

one sidelink transmission (e.g., one PSSCH transmission; in another example, one PSCCH/PSSCH transmission) is performed on each of the

$${N}_{s c h e}^{SL}$$

resources. For example, this is applicable to the case that

$${grant}_{0}^{SL}$$

is one sidelink dynamic grant.

In another example, according to the indication of

$${DCI}_{0}^{SL} ,$$

$${grant}_{0}^{SL}$$

is activated (or deactivated; or released). For example, this is applicable to the case that

$${grant}_{0}^{SL}$$

is one type 2 sidelink configured grant.

Embodiment 2 of the present invention may be performed by a physical layer entity of the UE.

In Embodiment 2 of the present invention, the “initial transmission” may be transmission performed on the resource

$${r}_{0}^{SL , sche} .$$

In Embodiment 2 of the present invention, the “initial transmission” may be the first transmission of one TB, and correspondingly, another transmission of one TB other than the “initial transmission” may be referred to as “re-transmission” of the TB.

In Embodiment 2 of the present invention, the “subchannel mapping scheme 1” may be replaced with the “contiguous RB-based PSSCH transmission”.

In Embodiment 2 of the present invention, the “subchannel mapping scheme 1” may be replaced with the “non-interlace RB-based PSSCH transmission”.

In Embodiment 2 of the present invention, the “subchannel mapping scheme 1” may be replaced with the “contiguous RB-based PSCCH/PSSCH transmission”.

In Embodiment 2 of the present invention, the “subchannel mapping scheme 1” may be replaced with the “non-interlace RB-based PSCCH/PSSCH transmission”.

In Embodiment 2 of the present invention, the “subchannel mapping scheme 2” may be replaced with the “interlace RB-based PSSCH transmission”.

In Embodiment 2 of the present invention, the “subchannel mapping scheme 2” may be replaced with the “non-contiguous RB-based PSSCH transmission”.

In Embodiment 2 of the present invention, the “subchannel mapping scheme 2” may be replaced with the “interlace RB-based PSCCH/PSSCH transmission”.

In Embodiment 2 of the present invention, the “subchannel mapping scheme 2” may be replaced with the “non-contiguous RB-based PSCCH/PSSCH transmission”.

Embodiment 2 of the present invention is applicable to a resource allocation mode based on network scheduling (e.g., a resource allocation mode 1 in an NR sidelink).

Therefore, according to Embodiment 2, the present invention provides a method. In a sidelink resource allocation mode based on network scheduling, a frequency domain parameter of a first scheduled sidelink resource is associated with a subchannel mapping scheme configured in a corresponding resource pool, so that most suitable indication information in DCI is separately determined for different subchannel mapping schemes, thereby preventing unnecessary signaling overhead.

### Embodiment 3

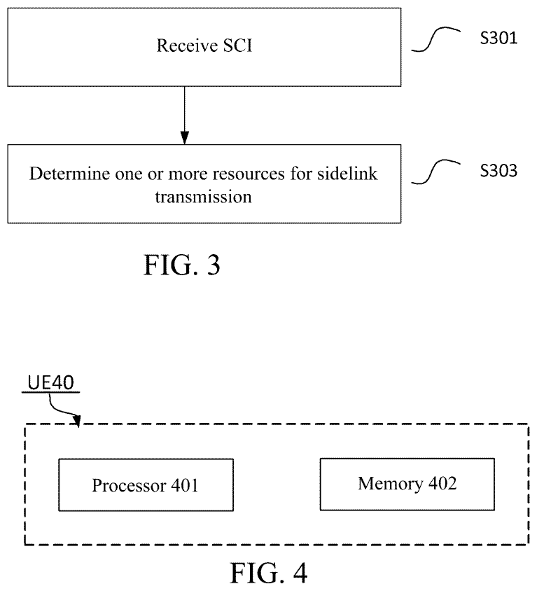

A method performed by a UE according to Embodiment 3 of the present invention will be described below with reference to FIG. 3.

FIG. 3 illustrates a flowchart corresponding to the method performed by a UE according to Embodiment 3 of the present invention.

As illustrated in FIG. 3, in Embodiment 3 of the present invention, the steps performed by the UE include: step S301 and step S303.

Specifically, in step S301, SCI is received.

For example, SCI received by the UE in one slot (e.g., denoted as

$${t}_{{i}_{0}}^{e , j , SCI} )$$

in one resource pool (e.g., the resource pool eⱼ) in one bandwidth part (e.g., the bandwidth part b₀) in one carrier (e.g., the carrier c₀) is denoted as

$${SCI}_{0}^{RA} .$$

The

$${SCI}_{0}^{RA}$$

may include first-stage SCI and/or second-stage SCI, wherein the first-stage SCI may correspond to SCI format 1-A, or another SCI format; the second-stage SCI may correspond to SCI format 2-A, or SCI format 2-B, or SCI format 2-C, or SCI format 2-D, or another SCI format.

The first-stage SCI may be carried in one PSCCH.

The PSCCH (or

$${SCI}_{0}^{RA} )$$

may be associated with (or scheduled for) one PSSCH.

The second-stage SCI may be carried in the PSSCH.

A transmission channel corresponding to the PSSCH may be an SL-SCH (Sidelink Shared Channel).

The PSSCH may carry one TB (e.g., one TB in the SL-SCH).

The PSCCH and the PSSCH may be multiplexed in one resource (e.g., denoted as

$${r}_{{i}_{0}}^{e , j , SCI} )$$

in the slot

$${t}_{{i}_{0}}^{e , j , SCI} ,$$

wherein the resource

$${r}_{{i}_{0}}^{e , j , SCI}$$

may correspond to

$${N}_{RA , SC}^{e , j}$$

subchannels of the resource pool eⱼ in the slot

$${t}_{{i}_{0}}^{e , j , SCI} ,$$

wherein

$${N}_{RA , SC}^{e , j}$$

may be an integer greater than or equal to 1.

A starting subchannel corresponding to the resource

$${r}_{{i}_{0}}^{e , j , SCI}$$

may be denoted as

$$s {c}_{{i}_{0} , 0}^{e , j , RA} .$$

The subchannel

$$s {c}_{{i}_{0} , 0}^{e , j , RA}$$

may be a subchannel with the lowest starting PRB index in the RB set with the lowest RB set index among the

$${N}_{RA , SC}^{e , j}$$

subchannels. For example, this is applicable to (or applicable only to) the case of an unlicensed spectrum. In another example, this is applicable to (or applicable only to) an operation with shared spectrum channel access.

The subchannel

$$s {c}_{{i}_{0} , 0}^{e , j , RA}$$

may be a subchannel with the lowest type 2A subchannel index in the RB set with the lowest RB set index among the

$${N}_{RA , SC}^{e , j}$$

subchannels. For example, this is applicable to the case that the resource pool eⱼ (or the bandwidth part b₀, or the carrier c₀) uses the subchannel mapping scheme 2.

The subchannel

$$s {c}_{{i}_{0} , 0}^{e , j , RA}$$

may be a subchannel with the lowest subchannel index among the

$${N}_{RA , SC}^{e , j}$$

subchannels, wherein the “subchannel index” here may be related to the subchannel mapping scheme used for the resource pool eⱼ (or the bandwidth part b₀, or the carrier c₀). For example, for the subchannel mapping scheme 1, the subchannel

$$s {c}_{{i}_{0} , 0}^{e , j , RA}$$

may be represented by the type 1 subchannel index. In another example, for the subchannel mapping scheme 2, the subchannel

$$s {c}_{{i}_{0} , 0}^{e , j , RA}$$

may be represented by the type 2B subchannel index. In another example, for the subchannel mapping scheme 2, the subchannel

$$s {c}_{{i}_{0} , 0}^{e , j , RA}$$

may be represented by the type 2C subchannel index.

The subchannel

$$s {c}_{{i}_{0} , 0}^{e , j , RA}$$

may be a subchannel on which a PRB with the lowest PRB index of the PSCCH is located.

Furthermore, in step S303, one or more resources for sidelink transmission are determined.

For example, according to the indication in

$${SCI}_{0}^{R A} ,$$

information about

$${N}_{RA , R}^{e , j}$$

sidelink resources (e.g., sequentially denoted as

$${r}_{{i}_{0}}^{e , j , RA} , {r}_{{i}_{1}}^{e , j , RA} , … , and {r}_{{i}_{{N}_{RA , R}^{e , j} - 1}}^{e , j , RA}$$

in chronological order) is determined, wherein

$${N}_{RA , R}^{e , j}$$

may be an integer greater than or equal to 1.

$${N}_{RA , R}^{e , j}$$

may be an integer less than or equal to

$${N}_{RA , R , max}^{e , j} ,$$

wherein

$${N}_{RA , R , max}^{e , j}$$

may be a value of one pre-defined or (pre-)configured parameter, or may be determined based on a value of one or more pre-defined or (pre-)configured parameters. For example,

$${N}_{RA , R , max}^{e , j}$$

may be (pre-)configured by using a parameter sl-MaxNumPerReserve. Specifically, for example, if

$${N}_{RA , R , max}^{e , j} = 2 , then {N}_{R A , R}^{e , j} = 1 , or {N}_{RA , R}^{e , j} = 2.$$

In another example, if

$${N}_{RA , R , max}^{e , j} = 3 , then {N}_{R A , R}^{e , j} = 1 , or {N}_{RA , R}^{e , j} = 2 , or {N}_{RA , R}^{e , j} = 3.$$

Each of the

$${N}_{RA , R}^{e , j}$$

resources may be used for one sidelink transmission (e.g., one PSSCH transmission; in another example, one PSCCH/PSSCH transmission).

Each of the

$${N}_{RA , R}^{e , j}$$

resources may be referred to as one PSSCH resource (or one PSCCH/PSSCH resource).

starting slots of the resources

$${r}_{{i}_{0}}^{e , j , RA} , {r}_{{i}_{1}}^{e , j , RA} , … , and {r}_{{i}_{{N}_{RA , R}^{e , j} - 1}}^{e , j , RA}$$

may be denoted as

$${t}_{{i}_{0}}^{e , j , RA} , {t}_{{i}_{1}}^{e , j , RA} , … , and {t}_{{i}_{{N}_{RA , R}^{e , j} - 1}}^{e , j , RA} ,$$

respectively. For

$$k ∈ [ 0 , {N}_{RA , R}^{e , j} - 1 ] ,$$

the number of slots corresponding to the resource

$${r}_{{i}_{k}}^{e , j , R A}$$

may be 1. Correspondingly, the slot

$${t}_{{i}_{k}}^{e , j , R A}$$

may be referred to as a slot in which the resource

$${r}_{{i}_{k}}^{e , j , R A}$$

is located.

The slot

$${t}_{{i}_{0}}^{e , j , SCI}$$

and the slot

$${t}_{{i}_{0}}^{e , j , R A}$$

may be the same slot.

The resource

$${r}_{{i}_{0}}^{e , j , R A}$$

and the resource

$${r}_{{i}_{0}}^{e , j , SCI}$$

may be the same resource (e.g., the resource

$${r}_{{i}_{0}}^{e , j , RA}$$

and the resource

$${r}_{{i}_{0}}^{e , j , SCI}$$

correspond to the same time domain resource and the same frequency domain resource).

The resources

$${r}_{{i}_{0}}^{e , j , RA} , {r}_{{i}_{1}}^{e , j , RA} , … , and {r}_{{i}_{{N}_{RA , R}^{e , j} - 1}}^{e , j , RA}$$

may be considered as resources assigned (or scheduled) by using

$${SCI}_{0}^{R A}$$

in the slot

$${t}_{{i}_{0}}^{e , j , SCI} .$$

The resources

$${r}_{{i}_{1}}^{e , j , RA} , … , and {r}_{{i}_{{N}_{RA , R}^{e , j} - 1}}^{e , j , RA}$$

may be considered as resources reserved by using

$${SCI}_{0}^{R A}$$

in the slot

$${t}_{{i}_{0}}^{e , j , SCI} .$$

### For

$${N}_{RA , R}^{e , j} = 1 ,$$

it may be considered that no resource is reserved by using

$${SCI}_{0}^{R A} .$$

For

$$k ∈ [ 0 , {N}_{RA , R}^{e , j} - 1 ] ,$$

a starting RB set (e.g., the RB set with the lowest RB set index; in another example, the RB set with the lowest starting (or “lowest”) PRB index) of the resource

$${r}_{{i}_{k}}^{e , j , R A}$$

may be denoted as

$${rs}_{{i}_{k} , 0}^{e , j , R A} .$$

For example, this is applicable to (or applicable only to) an unlicensed spectrum and/or an operation with shared spectrum channel access.

Part or all of time domain information of the

$${N}_{RA , R}^{e , j}$$

resources (e.g.,

$${N}_{RA , R}^{e , j} ;$$

in another example, part or all of

$${t}_{{i}_{1}}^{e , j , RA} , … , and {t}_{{i}_{{N}_{RA , R}^{e , j} - 1}}^{e , j , RA} )$$

may be determined based on a “time resource indicator value (TRIV)” (e.g., denoted as RIV_{T}) indicated in

$${SCI}_{0}^{R A} .$$

RIV_{T} may be indicated by a “time resource assignment” field in

$${SCI}_{0}^{R A} .$$

Part or all of frequency domain information of the

$${N}_{RA , R}^{e , j}$$

resources (e.g., part or all of

$${sc}_{{i}_{1} , 0}^{e , j , RA} , … , and {sc}_{{i}_{{N}_{RA , R}^{e , j} - 1} , 0}^{e , j , RA} )$$

may be determined based on one or more of the following:
A “frequency resource indicator value (FRIV)” (e.g., denoted as RIV_{F}) indicated by

$${SCI}_{0}^{R A} .$$

A “subchannel resource indicator value (SCRIV)” (e.g., denoted as RIV_{SC}) indicated by

$${SCI}_{0}^{R A} .$$

An “RB set resource indicator value (RSRIV)” (e.g., denoted as RIV_{RS}) indicated by

$${SCI}_{0}^{R A} .$$

Optionally, if the type 1 sidelink frequency resource assignment condition is satisfied, then one or more of the following hold true:
RIV_{F} may be indicated by a “frequency resource assignment” field in

$${SCI}_{0}^{R A} ,$$

wherein the size of the “frequency resource assignment” field may be denoted as

$${N}_{a l l}^{FRA}$$

(e.g., in bits), and

$${N}_{a l l}^{FRA}$$

may be an integer greater than or equal to 0.
Each of the

$${N}_{RA , R}^{e , j}$$

resources may correspond to the same number of subchannels (e.g., denoted

$${N}_{RA , SC}^{e , j} ) .$$

For

$$k ∈ [ 0 , {N}_{RA , R}^{e , j} - 1 ] ,$$

the

$${N}_{RA , SC}^{e , j}$$

subchannels corresponding to the resource

$${r}_{{i}_{k}}^{e , j , RA}$$

may be

$${N}_{RA , SC}^{e , j}$$

contiguous subchannels.
RIV_{F} may be used to indicate a starting subchannel (e.g., denoted as

$${sc}_{{i}_{1} , 0}^{e , j , RA} , … , and {sc}_{{i}_{{N}_{RA , R}^{e , j} - 1} , 0}^{e , j , RA} ,$$

respectively) of each of the resources

$${r}_{{i}_{1}}^{e , j , RA} , … , and {r}_{{i}_{{N}_{RA , R}^{e , j} - 1}}^{e , j , RA} , and$$

wherein

$${sc}_{{i}_{1} , 0}^{e , j , RA} , … , and {sc}_{{i}_{{N}_{RA , R}^{e , j} - 1} , 0}^{e , j , RA}$$

may be represented by the type 1 subchannel index.
For

$${N}_{RA , R , max}^{e , j} = 2 , {RIV}_{F}$$

may be equal to

$$s {c}_{{i}_{1} , 0}^{e , j , RA} + {Σ}_{x = 1}^{{N}_{RA , SC}^{e , j} - 1} ( {N}_{SC}^{e , j} + 1 - x ) .$$

For

$${N}_{RA , R , max}^{e , j} = 3 ,$$

RIV_{F} may be equal to

$$s {c}_{{i}_{1} , 0}^{e , j , RA} + s {c}_{{i}_{2} , 0}^{e , j , RA} \cdot ( {N}_{S C}^{e , j} + 1 - {N}_{RA , SC}^{e , j} ) + {{Σ}_{x = 1}^{{N}_{RA , SC}^{e , j} - 1} ( {N}_{S C}^{e , j} + 1 - x )}^{2} .$$

For

$${N}_{RA , R , max}^{e , j} = 2 , {N}_{a l l}^{FRA}$$

may be equal to

$$⌈ {log}_{2} ( \frac{{N}_{SC}^{e , j} ( {N}_{SC}^{e , j} + 1 )}{2} ) ⌉ .$$

For

$${N}_{RA , R , max}^{e , j} = 3 , {N}_{a l l}^{FRA}$$

may be equal to

$$⌈ {log}_{2} ( \frac{{N}_{SC}^{e , j} ( {N}_{SC}^{e , j} + 1 ) ( 2 {N}_{SC}^{e , j} + 1 )}{6} ) ⌉ .$$

Optionally, if the type 2 sidelink frequency resource assignment condition is satisfied, then one or more of the following hold true:
Each of the

$${N}_{RA , R}^{e , j}$$

resources may correspond to the same number of RB sets (e.g., denoted as

$${N}_{RA , RS}^{e , j} ) .$$

RB set allocation schemes used to determine (one or more) RB sets for the resources

$${r}_{{i}_{0}}^{e , j , RA} , {r}_{{i}_{1}}^{e , j , RA} , … , and {r}_{{i}_{{N}_{RA , R}^{e , j} - 1}}^{e , j , RA} ,$$

respectively may be the same. For example, for k∈

$$[ 0 , {N}_{RA , R}^{e , j} - 1 ] , {N}_{RA , RS}^{e , j}$$

RB sets in which the resource

$${r}_{{i}_{k}}^{e , j , R A}$$

is located may be

$${N}_{RA , RS}^{e , j}$$

RB sets determined according to the RB set allocation scheme 2A. In another example, for

$$k ∈ [ 0 , {N}_{RA , R}^{e , j} - 1 ] , {N}_{RA , RS}^{e , j}$$

RB sets in which the resource

$${r}_{{i}_{k}}^{e , j , R A}$$

is located may be

$${N}_{RA , RS}^{e , j}$$

RB sets determined according to the RB set allocation scheme 2B. In another example, for

$$k ∈ [ 0 , {N}_{RA , R}^{e , j} - 1 ] , {N}_{RA , RS}^{e , j}$$

RB sets in which the resource

$${r}_{{i}_{k}}^{e , j , R A}$$

is located may be

$${N}_{RA , RS}^{e , j}$$

RB sets determined according to the RB set allocation scheme 2C.
RIV_{RS} may be used to indicate a starting RB set

$$( i . e . , {rs}_{{i}_{1} , 0}^{e , j , RA} , … , and {rs}_{{i}_{{N}_{RA , R}^{e , j} - 1} , 0}^{e , j , RA} )$$

of each of the resources

$${rs}_{{i}_{1}}^{e , j , RA} , … , and {r}_{{i}_{{N}_{RA , R}^{e , j} - 1}}^{e , j , RA} , and {N}_{R A , R S}^{e , j} .$$

RIV_{RS} may be indicated by

$${N}_{R S}^{FRA}$$

bits (e.g.,

$${N}_{R S}^{FRA}$$

most significant bits; in another example,

$${N}_{R S}^{FRA}$$

least significant bits) in the “frequency resource assignment” field, wherein

$${N}_{R S}^{FRA}$$

may be an integer greater than or equal to 0.
RIV_{RS} may be indicated by an “RB set resource assignment” field in

$${SCI}_{0}^{R A} ,$$

wherein the size of the “RB set resource assignment” field may be equal to

$${N}_{RS}^{FRA} .$$

$${N}_{R S}^{FRA}$$

may be determined based on one or more factors including part or all of

$${N}_{RA , R , max}^{e , j} and {N}_{R S}^{e , j} .$$

For example, for

$${N}_{RA , R , max}^{e , j} = 2 , {N}_{R S}^{FRA}$$

may be equal to

$$⌈ {log}_{2} ( \frac{{N}_{R S}^{e , j} ( {N}_{R S}^{e , j} + 1 )}{2} ) ⌉ .$$

In another example, for

$${N}_{RA , R , max}^{e , j} = 3 , {N}_{RS}^{FRA}$$

may be equal to

$$⌈ {log}_{2} ( \frac{{N}_{RS}^{e , j} ( {N}_{RS}^{e , j} + 1 ) ( 2 {N}_{R s}^{e , j} + 1 )}{6} ) ⌉ .$$

For

$${N}_{RA , R , max}^{e , j} = 2 ,$$

RIV_{RS} may be equal to

$$r {s}_{{i}_{1} , 0}^{e , j , RA} + {Σ}_{x = 1}^{{N}_{RA , RS}^{e j} - 1} ( {N}_{R S}^{e , j} + 1 - x ) .$$

For

$${N}_{RA , R , max}^{e , j} = 3 ,$$

RIV_{RS} may be equal to

$$r {s}_{{i}_{1} , 0}^{e , j , RA} + r {s}_{{i}_{2} , 0}^{e , j , RA} \cdot ( {N}_{R S}^{e , j} + 1 - {N}_{RA , RS}^{e , j} ) + {{Σ}_{x = 1}^{{N}_{RA , RS}^{e , j} - 1} ( {N}_{R S}^{e , j} + 1 - x )}^{2} .$$

For

$$k ∈ [ 0 , {N}_{RA , R}^{e , j} - 1 ] ,$$

the same intra-RB-set subchannel allocation scheme (e.g., the intra-RB-set subchannel allocation scheme 2A; in another example, the intra-RB-set subchannel allocation scheme 2B; in another example, the intra-RB-set subchannel allocation scheme 2C) may be used for each of the

$${N}_{RA , RS}^{e , j}$$

RB sets in which the resource

$${r}_{{i}_{k}}^{e , j , R A}$$

is located.
For

$$k ∈ [ 0 , {N}_{RA , R}^{e , j} - 1 ] ,$$

the same set of subchannels (e.g., the type 2A subchannel index is used to represent subchannels in the set of subchannels) may be determined for each of the

$${N}_{RA , RS}^{e , j}$$

RB sets in which the resource

$${r}_{{i}_{k}}^{e , j , R A}$$

is located. The set of subchannels may be a set (e.g., denoted as

$${SC}_{RA , RS}^{e , j} = \{ {sc}_{0}^{e , j , R A , R S} , {sc}_{1}^{e , j , R A , R S} , … , {sc}_{{N}_{RA , RS , SC}^{e , j} - 1}^{e , j , RA , RS} \} )$$

consisting of

$${N}_{RA , RS , SC}^{e , j}$$

subchannels wherein

$${N}_{RA , RS , SC}^{e , j}$$

may be an integer greater than or equal to 1.
RIV_{SC} may be used to indicate the set

$${SC}_{RA , RS}^{e , j}$$

of subchannels.
RIV_{SC} may be indicated by

$${N}_{SC}^{FRA}$$

bits (e.g.,

$${N}_{SC}^{FRA}$$

most significant bits; in another example,

$${N}_{SC}^{FRA}$$

least significant bits) in the “frequency resource assignment” field, wherein

$${N}_{SC}^{FRA}$$

may be an integer greater than or equal to 0.
RIV_{SC} may be indicated by a “subchannel resource assignment” field in

$${SCI}_{0}^{R A} ,$$

wherein the size of the “subchannel resource assignment” field may be equal to

$${N}_{SC}^{FRA} .$$

$${N}_{SC}^{FRA}$$

may be determined based on one or more factors including part or all of μ_{b,0},

$${N}_{INT , S C}^{e , j} , {N}_{S C}^{e , j , rs} , and {N}_{INT}^{e , j} .$$

For example, for

$${μ}_{b , 0} = 0 , {N}_{SC}^{FRA}$$

may be equal to

$$⌈ {log}_{2} ( \frac{{N}_{SC}^{e , j , rs} ( {N}_{SC}^{e , j , rs} + 1 )}{2} ) ⌉ .$$

In another example, for

$${μ}_{b , 0} = 1 , {N}_{SC}^{FRA}$$

may be equal to

$${N}_{SC}^{e , j , rs} .$$

$${N}_{all}^{FRA}$$

may be equal to the sum of

$${N}_{SC}^{FRA} and {N}_{RS}^{FRA} .$$

For μ_{b,0}=0 and

$$0 \leq {RIV}_{S C} < {N}_{SC}^{e , j , rs} ( {N}_{SC}^{e , j , rs} + 1 ) / 2 ,$$

the used intra-RB-set subchannel allocation scheme may be the intra-RB-set subchannel allocation scheme 2A, and RIV_{SC} may be defined as follows:

$$if ( {N}_{RA , RS , SC}^{e , j} - 1 ) \leq ⌊ {N}_{S C}^{e , j , rs} / 2 ⌋ , then$$

$${RIV}_{SC} = {N}_{SC}^{e , j , rs} ( {N}_{RA , RS , SC}^{e , j} - 1 ) + s {c}_{0}^{e , j , RA , RS}$$

$$otherwise ,$$

$${RIV}_{SC} = {N}_{S C}^{e , j , rs} ( {N}_{S C}^{e , j , rs} - {N}_{RA , RS , SC}^{e , j} + 1 ) + ( {N}_{SC}^{e , j , rs} - 1 - s {c}_{0}^{e , j , R A , R S} )$$

For μ_{b,0}=0 and

$${RIV}_{S C} \geq {N}_{SC}^{e , j , rs} ( {N}_{SC}^{e , j , rs} + 1 ) / 2 ,$$

the used intra-RB-set subchannel allocation scheme may be the intra-RB-set subchannel allocation scheme 2B.
For μ_{b,0}=1, the used intra-RB-set subchannel allocation scheme may be the intra-RB-set subchannel allocation scheme 2C. Specifically, for example, the set

$${SC}_{RA , RS}^{e , j}$$

may be indicated by a bitmap with the size being

$${N}_{SC}^{e , j , rs}$$

bits. For example, bits 0, 1, . . . , and

$${N}_{SC}^{e , j , rs} - 1$$

in the bitmap are respectively used to indicate whether subchannels (e.g., represented by the type 2A subchannel index) 0, 1, . . . , and

$${N}_{SC}^{e , j , rs} - 1$$

### in one RB set are in the set

$$S {C}_{RA , RS}^{e , j}$$

(e.g., if a value of a specific bit in the bitmap is 1, it indicates that the corresponding subchannel is in the set

$$S {C}_{RA , RS}^{e , j} ;$$

otherwise, the subchannel is not in the set

$$S {C}_{RA , RS}^{e , j} ) .$$

The type 1 sidelink frequency resource assignment condition may include one or more of the following (e.g., any of the combinations made by way of “and” or “or”):
The resource pool eⱼ (or the bandwidth part b₀, or the carrier c₀) uses the subchannel mapping scheme 1.
The resource pool eⱼ (or the bandwidth part b₀, or the carrier c₀) uses the non-interlace-based PSCCH/PSSCH transmission.
The resource pool eⱼ (or the bandwidth part b₀, or the carrier c₀) uses the non-interlace-based PSSCH transmission.
The resource pool eⱼ (or the bandwidth part b₀, or the carrier c₀) uses the contiguous RB-based PSCCH/PSSCH transmission.
The resource pool eⱼ (or the bandwidth part b₀, or the carrier c₀) uses the contiguous RB-based PSSCH transmission.

The type 1 sidelink frequency resource assignment condition is applicable to a licensed spectrum.

The type 1 sidelink frequency resource assignment condition is applicable to an operation without shared spectrum channel access.

The type 1 sidelink frequency resource assignment condition is applicable to an unlicensed spectrum.

For the unlicensed spectrum, the type 1 sidelink frequency resource assignment condition is applicable to (or applicable only to) some subcarrier spacing configurations (e.g., a subcarrier spacing configuration 2 and a subcarrier spacing configuration 3; in another example, other subcarrier spacing configurations except for the subcarrier spacing configuration 0 and the subcarrier spacing configuration 1).

The type 1 sidelink frequency resource assignment condition is applicable to an operation with shared spectrum channel access.

For the operation with shared spectrum channel access, the type 1 sidelink frequency resource assignment condition is applicable to (or applicable only to) some subcarrier spacing configurations (e.g., a subcarrier spacing configuration 2 and a subcarrier spacing configuration 3; in another example, other subcarrier spacing configurations except for the subcarrier spacing configuration 0 and the subcarrier spacing configuration 1).

The type 2 sidelink frequency resource assignment condition may include one or more of the following (e.g., any of the combinations made by way of “and” or “or”):
The resource pool eⱼ (or the bandwidth part b₀, or the carrier c₀) uses the subchannel mapping scheme 2.
The resource pool eⱼ (or the bandwidth part b₀, or the carrier c₀) uses the interlace-based PSCCH/PSSCH transmission.
The resource pool eⱼ (or the bandwidth part b₀, or the carrier c₀) uses the interlace-based PSSCH transmission.
The resource pool eⱼ (or the bandwidth part b₀, or the carrier c₀) uses the non-contiguous RB-based PSCCH/PSSCH transmission.
The resource pool eⱼ (or the bandwidth part b₀, or the carrier c₀) uses the non-contiguous RB-based PSSCH transmission.

The type 2 sidelink frequency resource assignment condition is applicable to (or applicable only to) an unlicensed spectrum. For the unlicensed spectrum, the type 1 sidelink frequency resource assignment condition is applicable to (or applicable only to) μ_{b,0}∈{0, 1}.

The type 2 sidelink frequency resource assignment condition is applicable to (or applicable only to) an operation with shared spectrum channel access. For the operation with shared spectrum channel access, the type 1 sidelink frequency resource assignment condition is applicable to (or applicable only to) μ_{b,0}∈{0, 1}.

The type 2 sidelink frequency resource assignment condition is applicable to (or applicable only to) an unlicensed spectrum.

For the unlicensed spectrum, the type 2 sidelink frequency resource assignment condition is applicable to (or applicable only to) some subcarrier spacing configurations (e.g., a subcarrier spacing configuration 0; in another example, a subcarrier spacing configuration 1).

The type 2 sidelink frequency resource assignment condition is applicable to (or applicable only to) an operation with shared spectrum channel access.

For the operation with shared spectrum channel access, the type 2 sidelink frequency resource assignment condition is applicable to (or applicable only to) some subcarrier spacing configurations (e.g., a subcarrier spacing configuration 0; in another example, a subcarrier spacing configuration 1).

Embodiment 3 of the present invention may be performed by a physical layer entity of the UE.

In Embodiment 3 of the present invention, the “subchannel mapping scheme 1” may be replaced with the “contiguous RB-based PSSCH transmission”.

In Embodiment 3 of the present invention, the “subchannel mapping scheme 1” may be replaced with the “non-interlace RB-based PSSCH transmission”.

In Embodiment 3 of the present invention, the “subchannel mapping scheme 1” may be replaced with the “contiguous RB-based PSCCH/PSSCH transmission”.

In Embodiment 3 of the present invention, the “subchannel mapping scheme 1” may be replaced with the “non-interlace RB-based PSCCH/PSSCH transmission”.

In Embodiment 3 of the present invention, the “subchannel mapping scheme 2” may be replaced with the “interlace RB-based PSSCH transmission”.

In Embodiment 3 of the present invention, the “subchannel mapping scheme 2” may be replaced with the “non-contiguous RB-based PSSCH transmission”.

In Embodiment 3 of the present invention, the “subchannel mapping scheme 2” may be replaced with the “interlace RB-based PSCCH/PSSCH transmission”.

In Embodiment 3 of the present invention, the “subchannel mapping scheme 2” may be replaced with the “non-contiguous RB-based PSCCH/PSSCH transmission”.

Embodiment 3 of the present invention is applicable to a resource allocation mode based on network scheduling (e.g., a resource allocation mode 1 in an NR sidelink).

Embodiment 3 of the present invention is applicable to a resource allocation mode (e.g., a resource allocation mode 2 in an NR sidelink) in which a transmitting UE autonomously selects a resource for transmission.

Therefore, according to Embodiment 3, the present invention provides a method. When one or more sidelink resources indicated in SCI are determined based on indication information of the SCI, a frequency domain parameter of the one or more sidelink resources is associated with a subchannel mapping scheme configured in a corresponding resource pool, and most suitable indication information in the SCI is separately determined for different subchannel mapping schemes, thereby preventing unnecessary signaling overhead.

### Variant Embodiment

Hereinafter, FIG. 4 is used to illustrate a user equipment, as a variant embodiment, that can perform the method performed by a user equipment described in detail above in the present invention.

FIG. 4 is a block diagram showing a user equipment according to the present invention.

As illustrated in FIG. 4, the user equipment (UE) 40 includes a processor 401 and a memory 402. The processor 401 may include, for example, a microprocessor, a microcontroller, or an embedded processor. The memory 402 may include, for example, a volatile memory (e.g., a random access memory (RAM)), a hard disk drive (HDD), a non-volatile memory (e.g., a flash memory), or other memories. The memory 402 has program instructions stored thereon. The instructions, when run by the processor 401, can perform the method performed by user equipment described in detail in the present invention.

The method and related user equipment according to the present invention have been described above in combination with preferred embodiments. It should be understood by those skilled in the art that the method shown above is only exemplary, and the above-described embodiments can be combined with one another as long as no contradiction arises. The method of the present invention is not limited to the steps or sequences illustrated above. The user equipment illustrated above may include more modules. Various identifiers illustrated above are only exemplary, and are not meant to be limiting. The present invention is not limited to specific information elements serving as examples of these identifiers. Those skilled in the art could make various alterations and modifications according to the teachings of the illustrated embodiments.

It should be understood by those skilled in the art that any set is its own subset. An empty set is a subset of any set. Part or all of the mathematical expressions, mathematical equations, or mathematical inequalities may be simplified or transformed or rewritten to some extent (e.g., merging constant terms, or interchanging two addition terms, or interchanging two multiplication terms, or moving a term from the left side of an equation or inequality to the right side after changing the plus or minus sign thereof, or moving a term from the right side of an equation or inequality to the left side after changing the plus or minus sign thereof, or the like). Mathematical expressions, mathematical equations, or mathematical inequalities before and after the simplification or transformation or rewriting may be considered to be equivalent to each other.

It should be understood that the above-described embodiments of the present invention may be implemented by software, hardware, or a combination of software and hardware. For example, various components in the user equipment in the above embodiments may be implemented by a plurality of devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present invention, the term “base station” may refer to a mobile communication data and/or control switching center having a certain transmission power and a certain coverage area, and, for example, having functions such as resource allocation and scheduling, and data reception and transmission. The term “user equipment” may refer to user mobile terminals, such as terminal devices that can wirelessly communicate with a base station or a micro base station, including a mobile phone, a laptop computer, and the like.

In addition, the embodiments of the present invention disclosed here may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic enables the processor to execute the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device performs the technical solutions described in the embodiments of the present invention.

In addition, each functional module or each feature of the user equipment used in each of the above embodiments may be implemented or executed by a circuit, and the circuit is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1: A method performed by a user equipment (UE), the method comprising:
receiving a DCI format 3_0 for a sidelink dynamic grant in sidelink resource allocation mode 1; and
performing one or more physical sidelink shared channel (PSSCH) transmissions scheduled by the DCI format 3_0, wherein; a lowest index of a resource block (RB) set allocation to an initial PSSCH transmission is indicated via a “Lowest index of the RB set allocation to the initial transmission” field of the DCI format 3_0.

2: A user equipment (UE), comprising:
a processor; and
a memory storing instructions,
wherein the processor is configured by the instructions to cause the UE to:
receive a DCI format 3_0 for a sidelink dynamic grant in sidelink resource allocation mode 1; and
perform one or more physical sidelink shared channel (PSSCH) transmissions scheduled by the DCI format 3_0, wherein a lowest index of a resource block (RB) set allocation to an initial PSSCH transmission is indicated via a “Lowest index of the RB set allocation to the initial transmission” field of the DCI format 3_0.

3: The UE according to claim 2, wherein
the DCI format 3_0 includes the “Lowest index of the RB set allocation to the initial transmission” field only in a case that a subchannel mapping scheme for an interlace RB-based physical sidelink control channel (PSCCH)/PSSCH transmission is used in a corresponding sidelink bandwidth part, and
the subchannel mapping scheme is applicable only to an operation with shared spectrum channel access.
